(19) United States
(12) Patent Application Publication
(10) Pub. No.: US 2015/0227590 A1
(43) Pub. Date: Aug. 13, 2015

(54) PATENT SEARCH AND DISPLAY METHODS AND SYSTEMS

(71) Applicant: Robert Anton Nissen, Edmonton (CA)

(72) Inventor: Robert Anton Nissen, Edmonton (CA)

(21) Appl. No.: 14/621,317

(22) Filed: Feb. 12, 2015

Related U.S. Application Data
(60) Provisional application No. 61/939,267, filed on Feb. 12, 2014.
(60) Provisional application No. 61/986,011, filed on Apr. 29, 2014.

(51) Int. Cl. G06F 17/30

(52) U.S. Cl. CPC G06F 17/30528; G06F 17/30864; G06F 17/30321; G06Q 50/184

(57) ABSTRACT

Methods of patent searching, displaying patent search results, and analyzing patent data are disclosed. Search methods permit a user to indirectly search the drawings of patents in a group of patents, by querying lists of part names extracted from patent descriptions.

### CROSS-REFERENCE TO RELATED APPLICATIONS

This application claims the benefit under 35 USC 119(e) of U.S. provisional application Ser. No. 61/939,267 filed Feb. 12, 2014 and U.S. provisional application Ser. No. 61/986,011 filed Apr. 29, 2014.

### TECHNICAL FIELD

This document relates to patent search and display methods and systems.

### BACKGROUND

Traditional patent search engines permit the searching of various fields of information—abstract, title, description, claims and bibliographic information.

### SUMMARY

A method for searching a group of patent references, one or more of the patent references having associated a) one or more drawings, and b) a specification, in which a) and b) contain corresponding part identifiers, which are each associated with a part name in the specification, the method comprising: displaying on one or more screens a form with one or more text entry query fields; in response to a user query event, performing with a processor a query, using text in at least one of the text entry query fields, of lists of part names, the lists being stored on a computer readable medium, each list being associated with a respective patent reference of the group; and displaying on the one or more screens a results list of one or more patent references found in the query.

A method for searching a group of patent references, one or more of the patent references having associated a) one or more drawings, and b) a specification, in which a) and b) contain corresponding part identifiers, which are each associated with a part name in the specification, the specification containing a title and abstract, the method comprising: displaying on one or more screens a search query interface with a text entry field; in response to a user query event, performing with a processor a query, using text in the text entry field, of an index of a combination of lists of part names and one or more of titles and abstracts, the lists and one or more of titles and abstracts being stored on a computer readable medium, each list and one or more of title and abstract being associated with a respective patent reference of the group; displaying on the one or more screens a results list of one or more patent references found in the query.

An apparatus for searching a group of patent references, one or more of the patent references having associated a) one or more drawings, and b) a specification, in which a) and b) contain corresponding part identifiers, which are each associated with a part name in the specification, the apparatus comprising: a server connected to the internet; the server having a form module configured to serve on request a form with one or more text entry query fields; the server connected to receive a user query event, the server having a query module configured to perform with a processor a query, using text in at least one of the text entry query fields received by the server in the user query event, of lists of part names, the lists being stored on a computer readable medium, each list being associated with a respective patent reference of the group; and the server having a results module configured to serve, in reply to the user query event, a results list of one or more patent references found in the query.

A method for searching a group of patent references, one or more of the patent references having associated a) one or more drawings, and b) a specification, in which a) and b) contain corresponding part identifiers, which are each associated with a part name in the specification, the method comprising: displaying on one or more screens a compare interface with an identifier of a source patent reference from the group of patent references; in response to a user find related event, performing with a processor a comparison, between a list of part names associated with the source patent reference, and lists of part names stored on a computer readable medium, each list in the list of part names being associated with a respective patent reference of the group of patent references; displaying on the one or more screens a results list of one or more patent references that were found in the comparison to be similar to the source patent reference.

A method of displaying a patent reference, the patent reference having associated a) one or more drawings, and b) a specification, in which a) and b) contain part identifiers, which are each associated with a part name having a set of one or more occurrences in the specification, at least some of the sets having a plurality of occurrences of the respective part name in the specification, the method comprising: storing a modified specification on a computer readable medium; displaying on one or more screens at least a portion of the modified specification; in which, for each set of one or more occurrences of a part name, each occurrence of the respective part name in the set is adjacent to or contained at least partially within a respective wrapper markup element that is within the modified specification and has a wrapper identifier that is common to the set but distinct from the wrapper identifiers of the other sets. In some cases in which, for each part name, part identifier, or combination of part identifier with associated part name, a link is displayed to use the respective wrapper identifier to one or more of flag, scroll to, or initiate a display event of, one or more occurrences in the set of one or more occurrences in the modified specification for the respective part name, on a user selection event of a respective link.

A method of generating the modified specification, the method comprising: parsing the specification with one or more processor to identify each part name and producing the modified specification by inserting the corresponding wrapper markup element with wrapper identifier in the specification; and storing the modified specification on a computer readable medium.

A method of analyzing a patent reference, the patent reference having associated a) one or more drawings, and b) a specification, in which a) and b) contain part identifiers, which are each associated with a part name having a set of one or more occurrences in the specification, at least some of the sets having a plurality of occurrences of the respective part name in the specification: parsing the specification with one or more processors to identify each part name and associated part identifier; producing a modified specification, in which, for each set of one or more occurrences of a part name, each occurrence of the respective part name in the set is adjacent to or contained at least partially within a respective wrapper markup element that is within the modified specification and has a wrapper identifier that is common to the set but distinct from the wrapper identifiers of the other sets; and storing the modified specification on a computer readable medium.

A method of displaying a patent reference, the patent reference having associated a) one or more drawings, and b) a specification, in which a) and b) contain identifiers, which are each associated with a name in the specification, the method comprising: displaying on one or more screens the specification; in which, within the specification, for each identifier, name, or combination of name and identifier, a link is provided, adjacent to or as part of the identifier, name, or combination of name and identifier, to one or more of flag, scroll to, or initiate a display event of, one or more occurrences in the specification of the respective identifier, name, or combination of name and identifier, on a user selection event of a respective link within the specification.

A method of displaying a patent reference, the patent reference having associated a) one or more drawings, and b) a specification, in which a) and b) contain part identifiers, which are each associated with a part name having a set of one or more occurrences in the specification, at least some of the sets having a plurality of occurrences of the respective part name in the specification, the method comprising: displaying on one or more screens a list of part identifiers with associated part names from the selected patent reference; in which, adjacent to or as part of each part name, part identifier, or combination of part identifier with associated part name, in the list, a forward link is displayed to one or more of scroll to, or initiate a display event of, a subsequent occurrence in the set of occurrences in the specification for the respective part name, part identifier, or combination of part name and part identifier, on a user selection event of a respective forward link; and in which, for each part name, part identifier, or combination of part name and part identifier in the list and associated with a part name of a set with a plurality of occurrences of the respective part name in the specification, further comprising displaying in the list, on one or more of a user selection event of a respective forward link or as part of displaying the list of part identifiers, a back link adjacent to or as part of the part name, part identifier, or combination of part name and part identifier, to one or more of scroll to, or initiate a display event of, a previous occurrence in the set of occurrences in the specification for the respective part name, part identifier, or combination of part name and part identifier, on a user selection event of the respective back link.

A method of displaying a patent reference, the patent reference having associated a) one or more drawings, and b) a specification, in which a) and b) contain identifiers, which are each associated with a name having a set of one or more occurrences in the specification, in which for at least a first name associated with a first identifier there exists in the specification a related name associated with a second identifier, the method comprising: displaying on one or more screens either i) a list of identifiers with associated names from the selected patent reference, ii) the specification, or i) and ii) concurrently; in which, for each first name, first identifier, or combination of first identifier with associated first name, a link is displayed to one or more of flag, scroll to, or initiate a display event of, one or more related names, second identifier, or related name and second identifier, in i), ii), or i) and ii), on a user selection event of a respective link.

A method of displaying a patent reference, the patent reference having associated a) one or more drawings, and b) a specification, in which a) and b) contain part identifiers, which are each associated with a part name having a set of one or more occurrences in the specification, the method comprising: displaying on one or more screens a list of part identifiers with associated part names from the selected patent reference; in which rows in the list are displayed in the form of a combination of part identifier with a respective part name to the left of the part identifier, in which the respective part names are right aligned, the combination is right aligned, or the respective part names and combination are right aligned.

A method of parsing a patent reference, the patent reference having associated a) one or more drawings, and b) a specification, in which a) and b) contain part identifiers, which are each associated with a part name having a set of one or more occurrences in the specification, the method comprising: determining with a processor if the specification of a selected patent reference originated from an optical character recognition process; and parsing the specification and using one or more validation modules to validate words in the specification as being part names or part identifiers; using validated words to generate a list of part identifiers with associated part names from the selected patent reference; in which if the specification is determined to have originated from an optical character recognition process, the validation module operates at a first level of restriction; in which if the specification is determined to have not originated from an optical character recognition process, the validation module operates at a second level of restriction, the first level being more restrictive than the second level.

A method for searching patent references, one or more of the patent references having associated a) one or more drawings, and b) a specification, in which a) and b) contain part identifiers, which are each associated with a part name in the specification, the method comprising: X) displaying on one or more screens a search results list, from a patent search engine, of one or more patent references; Y) identifying a user selection event associated with loading a selected patent reference from the search results list; and Z) in response to the user selection event, displaying on the one or more screens at least one or more of the drawings of the selected patent reference in conjunction with a list of part identifiers with associated part names from the selected patent reference.

A method of displaying a patent reference, the patent reference having associated a) one or more drawings, b) a specification, and c) claims, in which a) and b) contain part identifiers, which are each associated with a part name in the specification, one or more of the part names having corresponding names in the claims, the method comprising: displaying on one or more screens claims of the patent reference; in which, for each of one or more names in the claims, a link is provided in association with the respective name to one or more of flag, scroll to, or initiate a display event of one or more occurrences of the name in i) the specification, ii) a list of part names, part identifiers, or combinations of part identifier with associated part name from the patent reference, or i) and ii), on a user selection event of a respective link.

A method of displaying a patent reference, the patent reference having associated a) one or more drawings, and b) a specification, in which a) and b) contain part identifiers, which are each associated with a part name in the specification, in which the specification contains one or more red herring terms that are each equivalent to a respective part identifier but are not associated with the corresponding part name, the method comprising: displaying on one or more screens a list of part identifiers with associated part names from the selected patent reference; in which, for each part identifier, a link is provided to one or more of flag, scroll to, or initiate a display event of, one or more occurrences in the specification of the respective part identifier, excluding red herring terms, on a user selection event of a respective link; in which, for each red herring term equivalent to a respective part identifier, a red herring link is provided to one or more of flag, scroll to, or initiate a display event of, one or more occurrences in the specification of the red herring term, on a user selection event of a respective red herring link.

A method of updating information associated with a patent reference, the patent reference having associated a) one or more drawings, and b) a specification, in which a) and b) contain part identifiers, which are each associated with a part name in the specification, the method comprising: A) retrieving from one or more servers information relating to a patent reference; B) using the information to display on one or more screens a form containing a list of part identifiers with associated part names from the patent reference; C) in response to a user update list event, transmitting to the one or more servers i) an updated list, ii) update information associated with the user update list event, or i) and ii).

A method for searching patent references, the method comprising: displaying on one or more screens a search results list, from a patent search engine, of one or more patent references; identifying a user selection event associated with loading a selected patent reference from the search results list; storing identification information of the selected patent reference in a list of selected patent references; and displaying, on the one or more screens, the search results list or a subsequent search results list, in which patent references, which are in the same patent family as one or more patent references whose identification information is in the list of selected patent references, are flagged for the user.

A method for patent searching, the method comprising: displaying on one or more screens a search results list, from a patent search engine, of one or more patent references; identifying a user selection event associated with loading a patent reference from the search results list; and performing a function, using or as directed by one or more processors independent of the patent search engine, as a result of the user selection event.

A method for searching a group of patent references, the method comprising: displaying on one or more screens a query form; in response to a user query event, performing with a processor a query of the group of patent references; and displaying on the one or more screens a results list of three or more patent references found in the query, the results list comprising a sequence of drawings including one or more drawings from each of the three or more patent references, the drawings in the sequence being stacked horizontally and vertically adjacent one another on the one or more screens.

Methods of patent searching, displaying patent search results, and analyzing patent data are disclosed. Methods of crowd-sourcing data are also disclosed. Methods related to generating and optimizing part lists extracted from a patent specification are disclosed. Related systems are disclosed.

A method is disclosed for patent searching, the method comprising: displaying on one or more screens a search results list, from a patent search engine, of one or more patent references; identifying a user selection event associated with loading a patent reference from the search results list; and performing a function, using or as directed by one or more processors independent of the patent search engine, as a result of the user selection event.

A method is also disclosed comprising: displaying on one or more screens one or more drawings, of a patent reference, that contain one or more reference elements that correspond to a specification of the patent reference; displaying on the one or more screens a list of the one or more reference elements; updating the list in response to one or more user update commands; and storing an updated list of the one or more reference elements in an online database.

A method is also disclosed of displaying one or more patent figures in conjunction with a list of corresponding reference elements, in response to a patent reference user selection event. In various embodiments, there may be included any one or more of the following features: Boosting patent references in the results list based on occurrence frequency in the specification. The text entry query field is one of a plurality of query fields each associated with querying a respective set of information associated with the patent references. The query of lists of part names is carried out on an index exclusively containing lists of part names. The group of patent references comprises a substantial or complete collection of the patent references for one or more countries. Z) further comprises displaying the specification of the selected patent reference in conjunction with the list of part identifiers and part names and the at least one or more of the drawings. For each part name, part identifier, or combination of part identifier with associated part name, a link is provided to one or more of flag, scroll to, or initiate a display event of, one or more occurrences in the specification of the respective part name, part identifier, or combination of part identifier with associated part name on a user selection event of a respective link. In which: the specification contains one or more red herring terms that are each equivalent to a respective part identifier but are not associated with the corresponding part name; and in response to successive user selection events of a respective link, occurrences in the specification of the respective part identifier are cycled through by respective scroll to or display events, while excluding red herring terms. Z) further comprises: in response to the user selection event: i) if the selected patent reference has one or more drawings, displaying on the one or more screens at least one or more of the drawings of the selected patent reference in conjunction with a list of part identifiers with associated part names from the selected patent reference; or ii) if the selected patent reference does not have one or more drawings, displaying on the one or more screens one or more of the specification or bibliographic information associated with the selected patent reference. Displaying on the one or more screens one or more of the drawings of the patent reference in conjunction with the claims. Displaying on the one or more screens the specification of the patent reference in conjunction with the claims. Displaying on the one or more screens a list of part names, part identifiers, or combinations of part identifier with associated part name from the patent reference in conjunction with the claims. In response to the user update list event, displaying on the one or more screens the updated list. Screening the user update list event. Flagging the user update list event in the computer readable medium if the user update list event is below a predetermined quality threshold. Before A) generating the list by parsing the specification with a processor. A) further comprises displaying on the one or more screens one or more drawings of the patent reference in conjunction with the list. Storing on a computer readable medium in B) further comprises storing in a database of information associated with patent references. Prior to A), identifying a user selection event associated with loading the patent reference from a search results list, from a patent search engine, of one or more patent references. The search results list or a subsequent search results list is displayed with patent references, whose identification information is in the list of selected patent references, flagged in a different manner than are flagged patent references, whose identification information is not in the list of selected patent references but that are in the same patent family as one or more patent references whose identification information is in the list of selected patent references. The patent reference has associated a) one or more drawings and b) a specification, in which a) and b) contain corresponding part identifiers, which are each associated with a part name in the specification, and in which the function comprises displaying a list of part identifiers with associated part names from the selected patent reference in conjunction with at least some of the one or more drawings of the patent reference selected in the user selection event. The function further comprises parsing the specification to generate the list of part identifiers with associated part names. The function further comprises obtaining the specification through an optical character recognition process of an image version of the specification. The function further comprises displaying the specification in conjunction with the list of part identifiers with associated part names and the one or more drawings. Displaying further comprises displaying a search results output page generated by the patent search engine, in which identifying further comprises intercepting the user selection event. The function further comprises obtaining the one or more drawings and the specification from one or more online patent databases. Before displaying the search results lists, displaying for selection a list of patent search engines for entry of search query information for the patent search engine. The user selection event is a hyperlink click. The patent search engine is one or more of a commercial search engine or a national, regional, or international patent office search engine. Patent references include patent application references. A list of links, part identifiers, and associated part names from the selected patent reference, is displayed on the one or more screens concurrently with the modified specification. One or more sets of occurrences contain occurrences of variants of the part name, in which for each variant in a set the wrapper markup element for the variant has a second wrapper identifier that is common to the other occurrences of the variant but distinct from the wrapper identifiers and second wrapper identifiers of the other variants and the other sets. For each variant, part identifier, or combination of part identifier with associated variant, a variant link is displayed in the list to use the respective second wrapper identifier to one or more of flag, scroll to, or initiate a display event of, one or more occurrences in the set of occurrences in the modified specification for the respective variant, on a user selection event of a respective variant link. For each wrapper markup element having a second wrapper identifier, the wrapper markup element has a combined wrapper identifier, and the wrapper identifier comprises at least a first part of the combined wrapper identifier and the second wrapper identifier comprises at least a second part of the combined wrapper identifier. The first part comprises a prefix of the combined wrapper identifier, and the second part comprises a prefix and suffix of the combined wrapper identifier. One or more part identifiers are associated with two or more conflicting part names, each of the conflicting part names having a respective set of occurrences in the modified specification, in which for each set of occurrences of a conflicting part name, each occurrence of the respective conflicting part name in the set is adjacent to or contained at least partially within a respective wrapper markup element that is within the modified specification and has a wrapper identifier that is common to the set but distinct from the wrapper identifiers of the other sets. For each conflicting part name, part identifier, or combination of part identifier with associated conflicting part name, a link is displayed in the list to use the respective wrapper identifier to one or more of flag, scroll to, or initiate a display event of, one or more occurrences in the set of occurrences in the modified specification for the respective conflicting part name, on a user selection event of a respective link. On a user selection event the respective wrapper identifier is used to flag the occurrences in a set by modifying one or more style properties for the set. The modified specification contains one or more red herring terms that are each equivalent to a respective part identifier but are not associated with the corresponding part name, in which, for each set of occurrences of a part name associated with a part identifier equivalent to one or more red herring terms, the respective wrapper identifier used for flagging, scrolling, or displaying, for the set is distinct from the wrapper identifiers, if any, associated with the one or more red herring terms. Each wrapper markup element contains the part name, part identifier, or both part name and part identifier. The specification includes claims and a description, and in which, within the description, for each identifier, name, or combination of name and identifier, a link is provided, adjacent to or as part of the identifier, name, or combination of name and identifier, to one or more of flag, scroll to, or initiate a display event of, one or more occurrences in the description of the respective identifier, name, or combination of name and identifier, on a user selection event of a respective link within the description. Within the specification for each identifier, name, or combination of name and identifier, the link is provided to scroll to a subsequent occurrence in the specification of the respective identifier, name, or combination of name and identifier, on a user selection event of a respective link within the specification. Each link has an associated second link that is provided to scroll to a previous occurrence in the specification of the respective identifier, name, or combination of name and identifier, on a user selection event of a respective second link within the specification. A user selection event of a respective link makes visible one or more respective second links in the specification. The names include figure references, part names, or figure references and part names. The names include part names. The respective back links are hidden in the list in normal operation, and on selection of a respective forward link the respective back link becomes visible in the list. On selection of a back link or forward link associated with a first part identifier, a visible back link associated with a second part identifier becomes hidden or is removed. Adjacent to comprises displayed in the same row as. The names are part names and the identifiers are part identifiers. The related name has at least one word in common with the first name. The source patent reference comprises two or more patent references. The comparison is carried out using a more like this algorithm. Performing the comparison further comprising performing a comparison between one or more of the title and abstract associated with the source patent reference, and the titles and abstracts stored on the computer readable medium and each being associated with a respective patent reference of the group of patent references. Single character alphabetical words are not validated as part identifiers in the first level of restriction but are validated as part identifiers in the second level of restriction. Words starting with an alphabetical character and having one or more numbers are not validated as part identifiers in the first level of restriction but are validated as part identifiers in the second level of restriction. Numbers of multiples of five are given lower weight during validation in the first level than in the second level. Words equivalent to two or three character country codes in a list of country codes are not validated in the second level but are validated in the first level. Creating the index by indexing a text block of title, abstract, and list. Producing a list of part identifiers, associated part names, and either associated wrapper identifiers or identifiers associated with the associated wrapper identifiers. Receiving from a user a request to display the patent reference, and transmitting from the one or more servers information sufficient to display the updated list on one or more screens associated with the user. The one or more screens of stage A) are associated with a first user, and the one or more screens of stage E) are associated with a second user. Re-indexing the updated part list. Running a further query on the updated index.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a screenshot of a system for patent searching, displaying a search page from the USPTO.

FIG. 2 is a screenshot of the system of FIG. 1 displaying a search results output page from the USPTO.

FIG. 3 is a screenshot of a split screen display method with a reference element list (top left), specification (bottom left), and pdf with drawings (right) for a patent selected by a user from the output page of FIG. 2.

FIG. 4 is a screenshot of the system of FIG. 3 displaying a drop down list for navigating other patents stored from the search displayed in FIG. 2.

FIG. 5 is a screenshot of an alternate split screen method for the selected patent of FIG. 3.

FIG. 6 is a screenshot of the system of FIG. 1 displaying a drop down list for saving and selecting saved patents.

FIG. 7 is a screenshot of the system of FIG. 3 in which a text search has been carried out for part number 60.

FIG. 8 is a screenshot of an alternate split screen method for the selected patent of FIG. 3, and illustrates a list of the unique occurrences of each reference element.

FIG. 9 is a screenshot from a website for patent searching, offering a direct load of a patent or the selection of one or more patent search engines along with a normalized search form for entry of search query information for a variety of search engines.

FIG. 10 is a series of screenshots illustrating how to update a reference element list.

FIG. 11 is a system for carrying out a method of patent search, retrieval, and display.

FIG. 12 is a screenshot of a system for patent searching, illustrating an expandable list of reference elements and a method of updating the list.

FIG. 13A is a screenshot of a further system for patent searching and retrieval.

FIG. 13B is a screenshot of the system of FIG. 13A with a patent loaded in a new window.

FIG. 14 is a screenshot of the system of FIG. 13A showing results of a patent image search.

FIGS. 15-16 are screenshots of a search form that incorporates a query field for the entry of text to search for in the lists of parts of patents in a database of patents.

FIG. 17 is a screenshot of a patent display screen from the first result of the search of FIG. 16.

FIG. 18 is a screenshot of a patent display method for assisting in claim interpretation.

FIG. 19 is a screenshot of a further patent display screen.

FIG. 20 is a schematic of a server and database connected to perform the disclosed methods.

FIGS. 21-22 are screenshots of another split screen format.

### DETAILED DESCRIPTION

### Glossary

Patent reference=includes patent application references, such as US patent application publications, issued patents, design patents, applications, and publications, and documents filed at a patent office.

Group of patent references=two or more patent references, issued by the same or different jurisdictions (countries) and in some cases a substantial or complete collection of the patent references for one or more countries, for example the entire US collection from 1920 to present. The group may include an entire full text patent reference database or series of databases.

Specification=the text of a patent reference, includes at least the claims, abstract, and description, and in some cases other related fields. The specification may or may not contain a title. The specification may include a certificate of correction or reissue or reexamination.

Drawings=the set of pages of images associated with a patent reference, and visually showing embodiments disclosed in the patent reference. Drawings are also referred to as figures.

Abstract=the short technical and textual summary of the contents of a patent reference, used for patent searching.

Title=the descriptive title associated with a patent reference.

Detailed description=the part of the description of a patent reference that describes specific embodiments.

Description=the specification excluding claims and abstract. A description will generally have background information, summary, brief description of the figures (if any drawings are present), and detailed description sections, though other sections may be present as required such as technical field.

Claims=the part of the specification that define the exclusivity claimed in the patent reference.

Inventor=the individual or individuals who conceived of the inventive concept as defined by the claims.

Applicant=the entity who applied for a patent.

Classification=an identifier associated with a patent reference, the identifier derived from one or more patent classification systems, such as the USPC, IPC, or CPC, and associated with a particular category or categories of classes, which the subject matter of the patent reference relates to.

USPC=United States Patent Classification system

IPC=International Patent Classification system

CPC=Cooperative Patent Classification system

Part identifiers=includes numbers, letters, alphanumerical character strings, and various strings of different characters, including non-alphanumerical characters. Part identifiers have an associated or corresponding part name or part names in the specification of a patent reference, and part identifiers, if present in a patent reference, will appear in both the drawings and specification.

Part name=the name in the specification associated with a part identifier, the part identifier appearing in the drawings. Part names are often descriptive of a part or element that is shown in the drawings and associated, often with lead lines, with the part identifier.

List of part names=a list, for a particular patent reference, of the part names that appear in the patent reference.

Reference element=includes one or more of a part identifier and corresponding part name.

Screen=an electronically changeable display of information, such as a computer monitor, television, or surface upon which a projector projects an image.

Form (when used as a noun)=includes an image on a screen displayed to a user and may contain one or more fields for informational entry, and is associated with an activator for performing a function using the entered field data, for example a submit button for posting the update list 34 to the server 18.

Text entry query field/text entry field=a field, or one or more fields, on a form, in which a user is able to enter information, such as text, for use in a query, and including a text box.

Search query interface=a form set up to enable a user to execute searches.

User query event=an event initiated by the user and intended to submit user selected or entered query information, such as text, to a search engine for the purposes of performing and executing a search of records. Such an event may be triggered by a mouse click over a submit button on a form.

Query=a function performed by a processor or server where a search of documents is initiated by a user.

Processor=a computer or other computing device that is able to perform calculations and data analysis such as performing a query on a patent reference index.

Server=a processor that is connected to the internet to send forms to a user on receipt of a form request from the user, and to receive requests from a user, such as a perform search request.

Computer readable medium=includes memory such as RAM or a hard drive, flash drive, or other storage medium of bits and bytes of data used in computer processing.

Set of information associated with a patent reference=includes the abstract, description, claims, detailed description, bibliographic information (such as applicant, inventor, patent reference identifier), and other information.

User-entered search terms=search terms entered into a query field on a form by a user.

Index (when used as a noun)=includes a set of data extracted from a database and optimized for performing search queries on the set of data.

First location/second location=locations that are different from one another, for example a first location in a user's office and a second location at a remote server.

Parse=analyze the text data of, for example by reading through each word.

Validate=confirm by running through one or more checks.

Text block=a block of text information, derived from a source of one or more text passages, and may include raw data or data compressed from the original text passages.

Module=a portion of a computer readable medium in a processor that stores instructions for carrying out a particular function.

Compare interface=a form that permits a user to initiate a request to a processor to perform a comparison between patent references.

Identifier of a source patent reference=a character string that is unique to a particular patent reference and used for identifying the patent reference, such as an application, publication, or patent number.

User find related event=an event initiated by the user and intended to request that a processor finds patent references similar to a source patent reference.

More like this algorithm=an algorithm that may be performed by a processed in order to find documents that are like a source document. Example algorithms are offered by the ElasticSearch or SOLR lucene-based backends.

Database=includes a computer readable medium for storage and may include a document oriented or relational database, for example containing patent reference data.

HTML=Hyper Text Markup Language—a standard markup language used to create web pages.

DOM=document object model—a cross-platform and language-independent convention for representing and interacting with objects in various markup language documents.

JQUERY—a cross-platform JavaScript library designed to simplify the client-side scripting of HTML.

TF-IDF=term frequency-inverse document frequency—a numerical statistic that is intended to reflect how important a word is to a document in a collection or corpus.

OCR=optical character recognition

URL=a uniform resource locator (also known as a web address) is a specific character string that constitutes a reference to an online resource.

### END OF GLOSSARY

Immaterial modifications may be made to the embodiments described here without departing from what is covered by the claims.

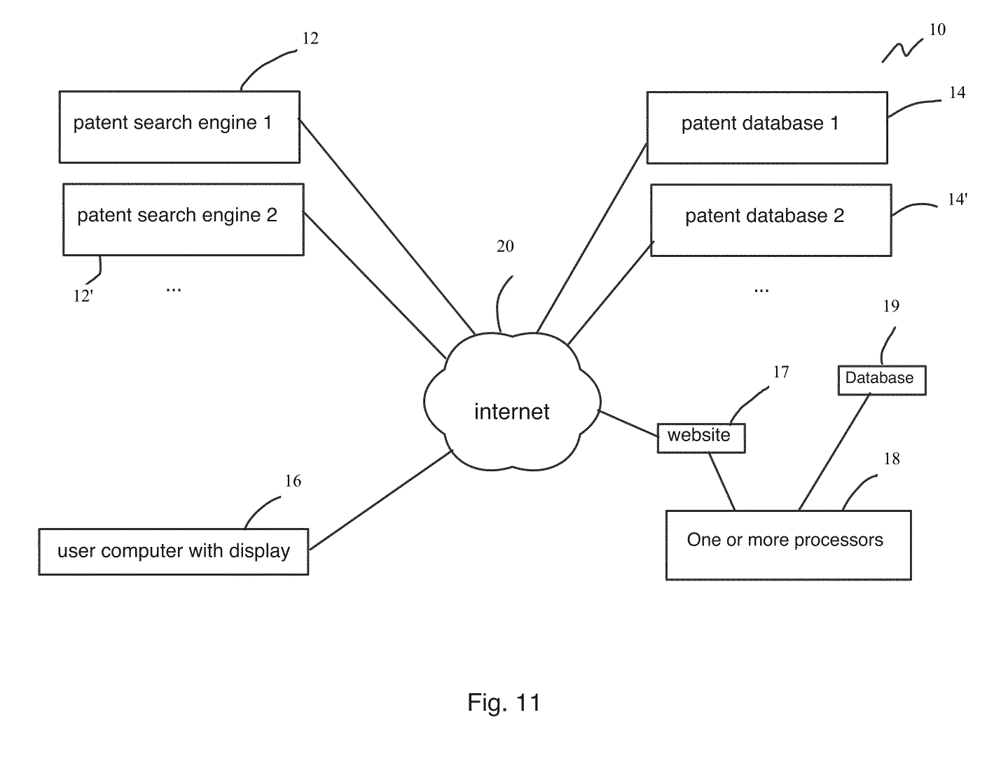

Referring to FIG. 11, a system 10 for carrying out a method of patent searching is displayed. The system 10 may incorporate one or more patent search engines 12, one or more patent databases 14, user equipment 16 such as a multi-purpose computer with display, and one or more processors 18, for example running a website 17 for carrying out the method using a network such as the internet 20. The components shown may communicate through connection lines to the internet 20 as shown. A user normally begins a patent search by navigating to a website 17 from equipment 16. To navigate to the page, the user may have had to first log in by entering a username and password.

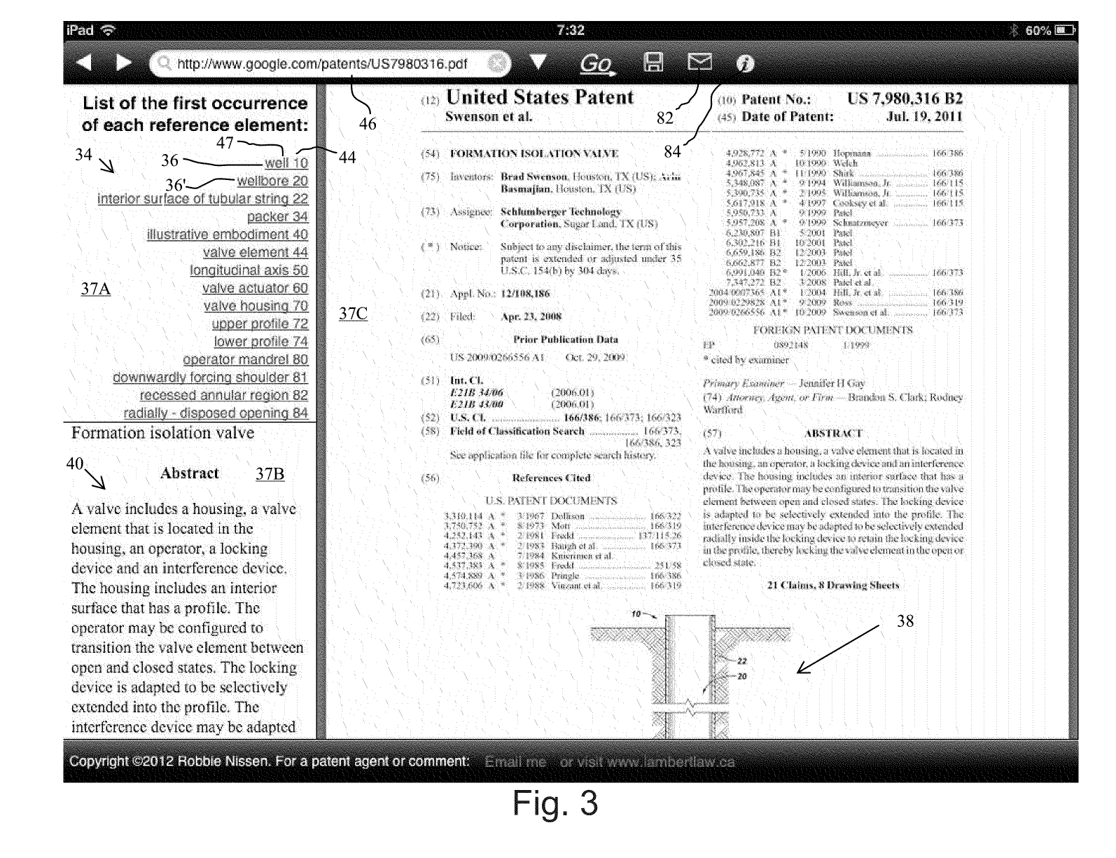

Part lists are useful for viewing and analyzing patents. Referring to FIGS. 3, 5, and 8, on user selection of a patent a list 34 of reference elements 36 may be generated using the specification 40, or may be loaded from a pre-generated database 19 accessible by or provided as part of one or more processors 18. In some cases the part list 34 may be auto-generated and entered into database 19, or may be manually entered, or auto-generated and then manually updated and saved in database 19 as described below. Exemplary methods of generating the list 34 are discussed in US patent publication nos. 20120204104 and 20090276694, and U.S. Pat. No. 8,160,306, all incorporated by reference. The lists 34 may be generated by parsing the specification. A preliminary step may include analyzing the specification, usually in the form of an html page, text data, list, array, or json object, and cutting out or ignoring irrelevant parts of the html, such as search engine headers, html code, claims, references cited by/citing lists, html trees, and other parts.

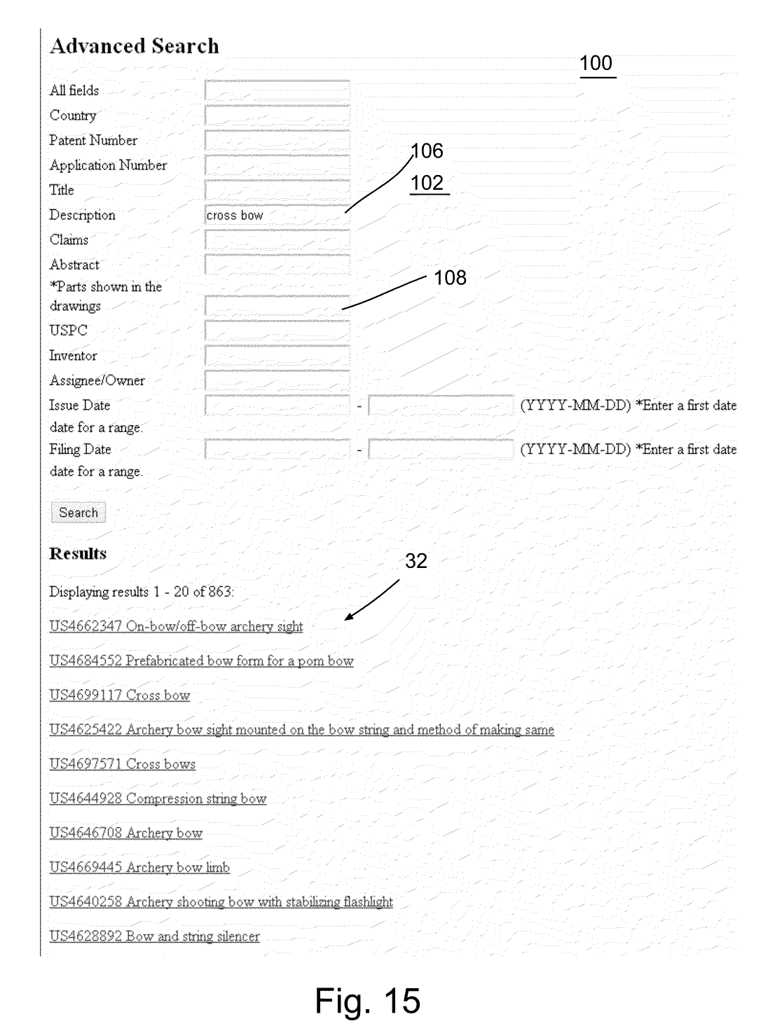

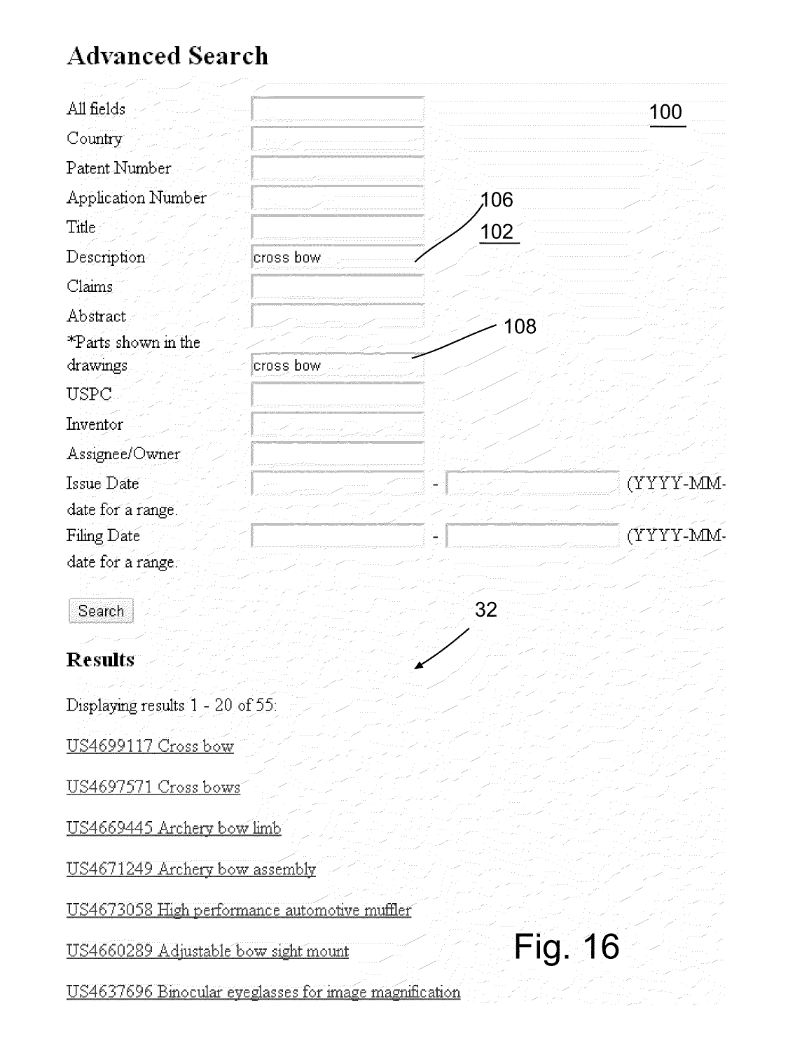

Referring to FIGS. 15-16 a system 100 for searching a group of patent references is illustrated. As shown one or more screens 102 display a form with one or more text entry query fields, such as fields 106, 108. Fields 106 and 108 are part of a plurality of query fields as shown, each associated with querying a respective set of information associated with the patent references. For example, field 106 is associated with searching the description of patents in the database, while field 108 is associated with searching the parts lists of patents in the database. In response to a user query event, such as entry of text in field 106 followed by clicking on the search button, a processor performs a query using a patent search engine. The results for FIG. 15 are illustrated. The first result shown does not in fact show a cross bow in the drawings. This is because the search was executed and satisfied by any description that contained the words cross and bow at any point in the document. Thus, in FIG. 16, a search is executed to drill down the results from the search of FIG. 15 to find more relevant results. By entering text in at least field 108 and starting a query, the text in 108 is used to search lists of part names, the lists being stored on a computer readable medium such as database 19 (FIG. 11), each list being associated with a respective patent reference of the group. The lists of part names may be generated, manually entered, or otherwise created by a combination of auto-generation and manual data entry methods. Creation of the parts list database precedes the operation of the method.

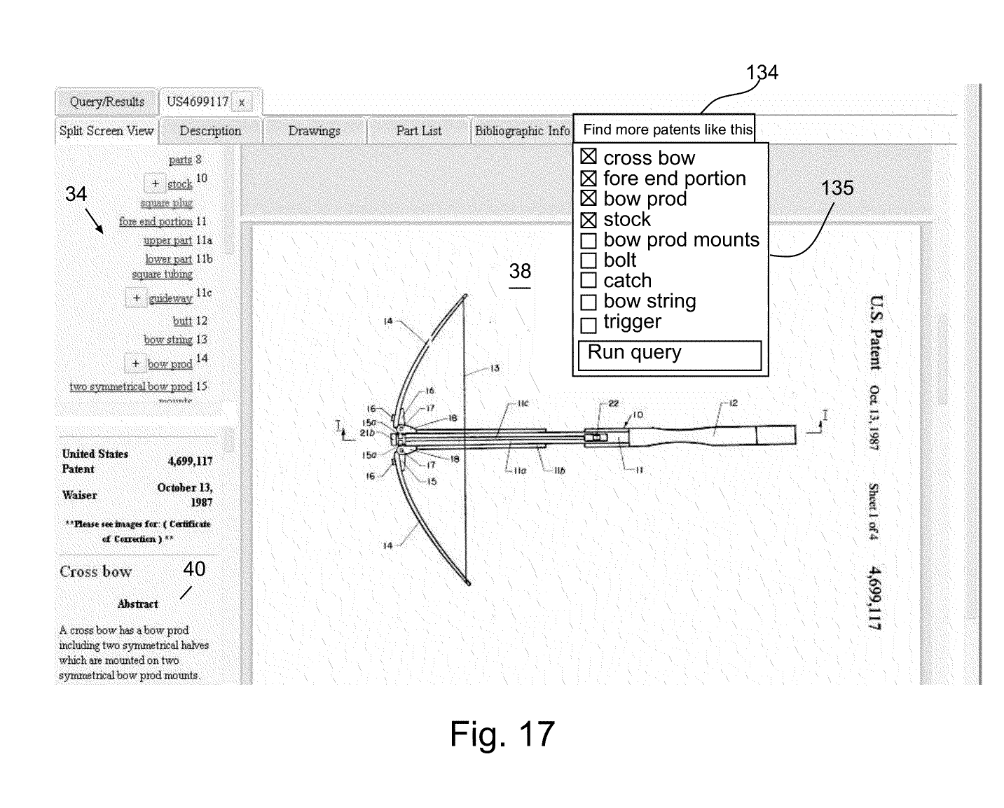

As shown, by drilling down the search to look for patents with cross and bow in part names shown in the drawings, a more targeted search is accomplished, yielding 55 results, or roughly 1/16 the results 32 of the description search. In fact, the first reference returned shows a cross bow in the parts list (FIG. 17). This method permits an individual to look for words that it wishes to see corresponding parts of which appearing in the drawings. This style of search is advantageous when the subject of the search includes homographs—words with multiple meanings, like well, swing, cross, head, and thousands of other words. Such words may appear in patents in the form of a noun, verb, or adjective, while the user merely desires to see results with use as a noun as such are more likely to indicate part names, though in other cases the other form of the word may be desired to be found in the parts list. However, by searching in the parts lists for such terms the likelihood is increased of returning results that use such terms in the noun sense or at least in finding parts that are named in the same fashion as the text query terms are intended to find results for.

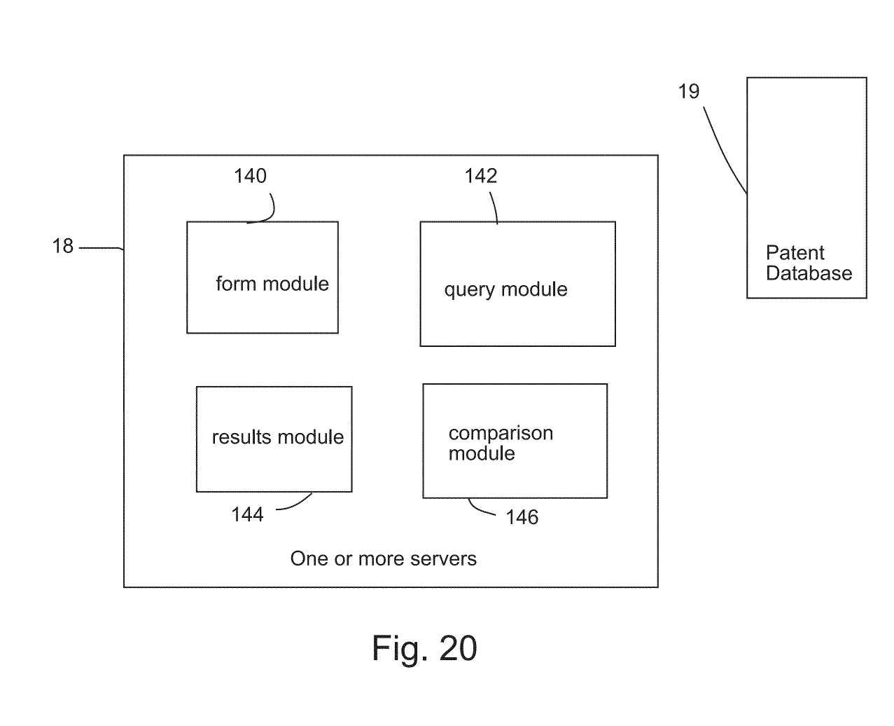

Referring to FIG. 20, an apparatus is shown for searching a group of patent references. A server 18 is connected to the internet. The server 18 has a form module 140 configured to serve on request a form, such as the FIG. 15 form, with one or more text entry query fields. The server 18 is also connected to receive a user query event. The server has a query module 142 configured to perform with a processor a query, using text in at least one of the text entry query fields received by the server in the user query event, of lists of part names, as described elsewhere in this document. The server 18 also has a results module 144 configured to serve, in reply to the user query event, a results list, such as the form shown in FIG. 15, of one or more patent references found in the query. A comparison module 146 may be provided for providing the more like this feature described elsewhere in this document. The server 18 may be connected to a patent database 19, which may include an index of lists of part names, for carrying out the query.

Having a database of part name lists permits other operations to be applied to a patent search. For example, references in the results list may be boosted based on occurrence frequency in the specification, or based on appearance in a parts list of a returned patent. In some cases field 108 may be part of a general search field, but the specific request to search for sub text within the parts lists may be invoked using an identifier like parts=X where X is the query text. In other cases, a search engine may have a single general search bar and text within that bar is searched in all fields, and results boosted if such text appears in part or fully in the parts list for a particular patent returned.

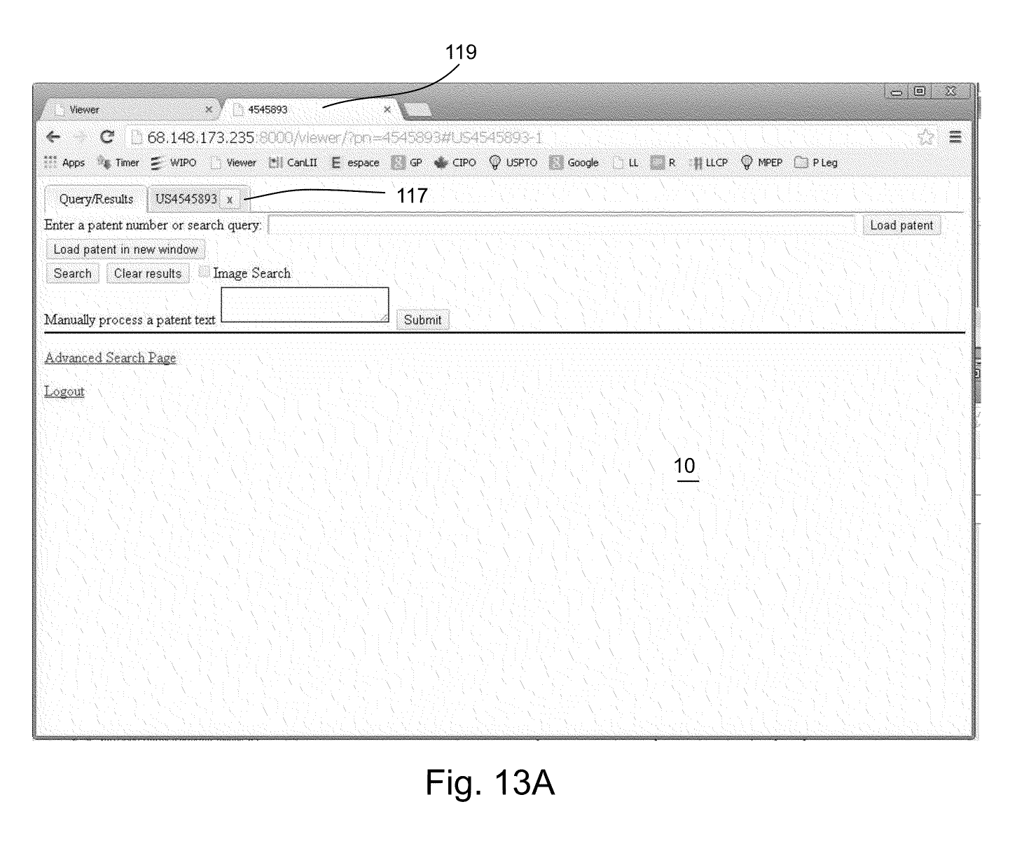

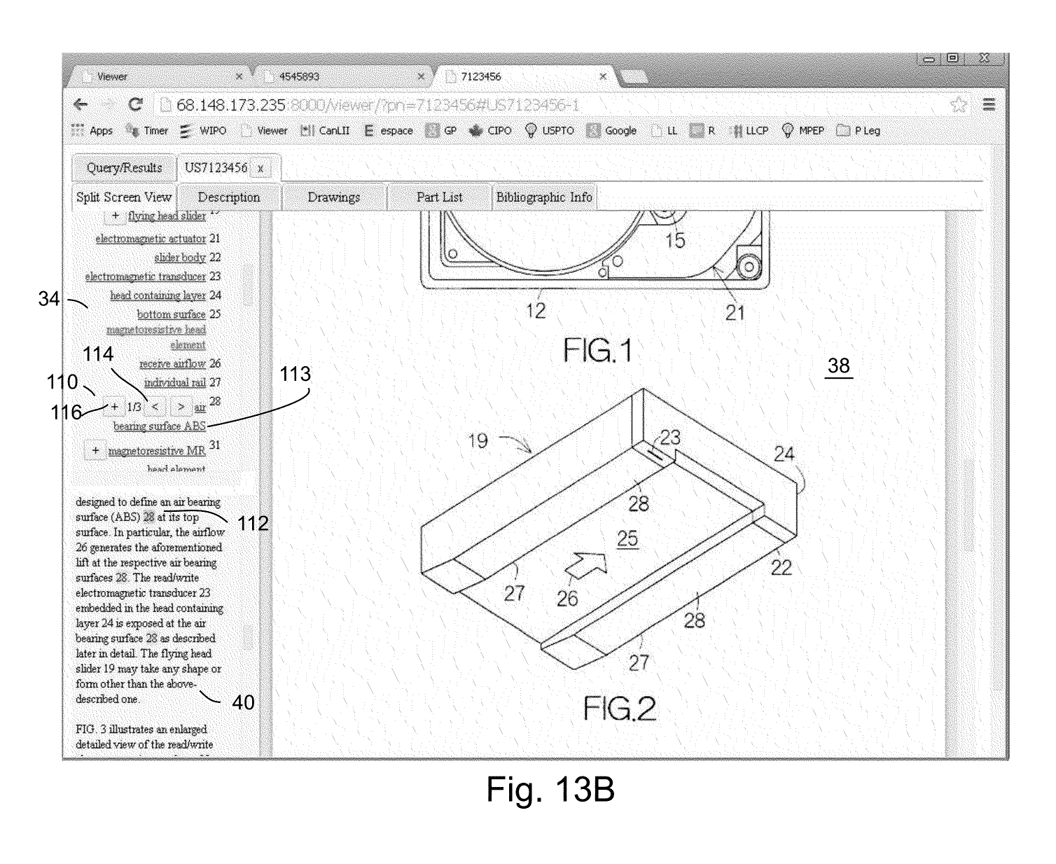

Referring to FIGS. 16 and 17 a further method for searching patent references is illustrated. In a stage X) one or more screens 102 display a search results list 32, from a patent search engine, of one or more patent references. In a stage Y) a user selection event is identified and associated with loading a selected patent reference from the search results list, in this case U.S. Pat. No. 4,699,117. In a stage Z), in response to the user selection event, one or more screens display at least one or more of the drawings 38 of the selected patent reference in conjunction with a list 34 of part identifiers with associated part names from the selected patent reference. Thus, the patent is displayed in a user friendly format within one click from the search results. The specification 40 may also be displayed. For each part name, part identifier, or combination of part identifier with associated part name, a link, such as links 110, is provided to one or more of flag, scroll to, or initiate a display event of, one or more occurrences in the specification 40 of the respective part name, part identifier, or combination of part identifier with associated part name on a user selection event of a respective link. Thus, when user clicks link 110 (butt 12), the system might highlight all occurrences of butt 12 in specification 40, and scroll through each occurrence. FIG. 13B is an illustration of this with U.S. Pat. No. 7,123,456 shown. As link 110 is clicked, specification 40 is scrolled through occurrences 112 of “air bearing surface ABS 28” in the description. Buttons 114 may appear to scroll forwards or backwards through occurrences. The link 110 may be in the form of a hyperlink. Further operation of FIG. 13B is described below.

Scrolling may be accomplished as follows. During generation of the list 34 by parsing the specification 40, whenever a part name is found and validated, the specification may have added an html wrapper, like a <SPAN> element around the part name, identifier, or both. This process is discussed elsewhere in this document. The wrapper may have a unique class or id that is requested in a scroll javascript operation upon clicking link 110. This style of search filters out red herring terms that are equal to part identifiers but are not intended to be used as such. For example years like “1990” above are red herring terms generally. In this case there may be a use of “28” to delineate a day of the month, and the parts list algorithm filters out such occurrences. Thus, when a link 110 is clicked successfully, and occurrences of the respective part identifier are cycled through by respective scroll to or display events, red herring terms are excluded.

In some cases a user may want to view the red herring terms, to ensure that no such terms were actually intended to be used as part names. For example, the drafter of the patent may have used the phrase “the 28” to indicate 28 as a part name. Because of the word “the” this use might not be caught by the parts list algorithm. Hence, a way to quickly search these excluded terms may be of use. A link, such as a link located over the part indicator 28 in the list 34 may be used to cycle through such terms.

Display events may include pop ups, for example a pop up over the parts list 34 of a relevant section of a specification that contains the occurrence of the element 110. Buttons 114 may appear on or adjacent the pop up (not shown) for cycling through the occurrences. A button 116 may be provided to expand the list of part names associated with the part indicator when there are more than one unique part names for a particular indicator.

Stage Z) may further comprise in response to the user selection event determining if the selected patent reference has one or more drawings. If yes, at least one or more of the drawings 38 of the selected patent reference may be displayed in conjunction with the part list 34. If no, one or more of the specification 40 or bibliographic information (not shown) associated with the selected patent reference may be displayed. Applications that don't contain figures are more likely to contain extraneous alphanumerics that may clutter the list of part names. Determining if figures are present may involve searching for the words FIG, FIGURE, FIGS, DRAWINGS, DRAWING, and other variants.

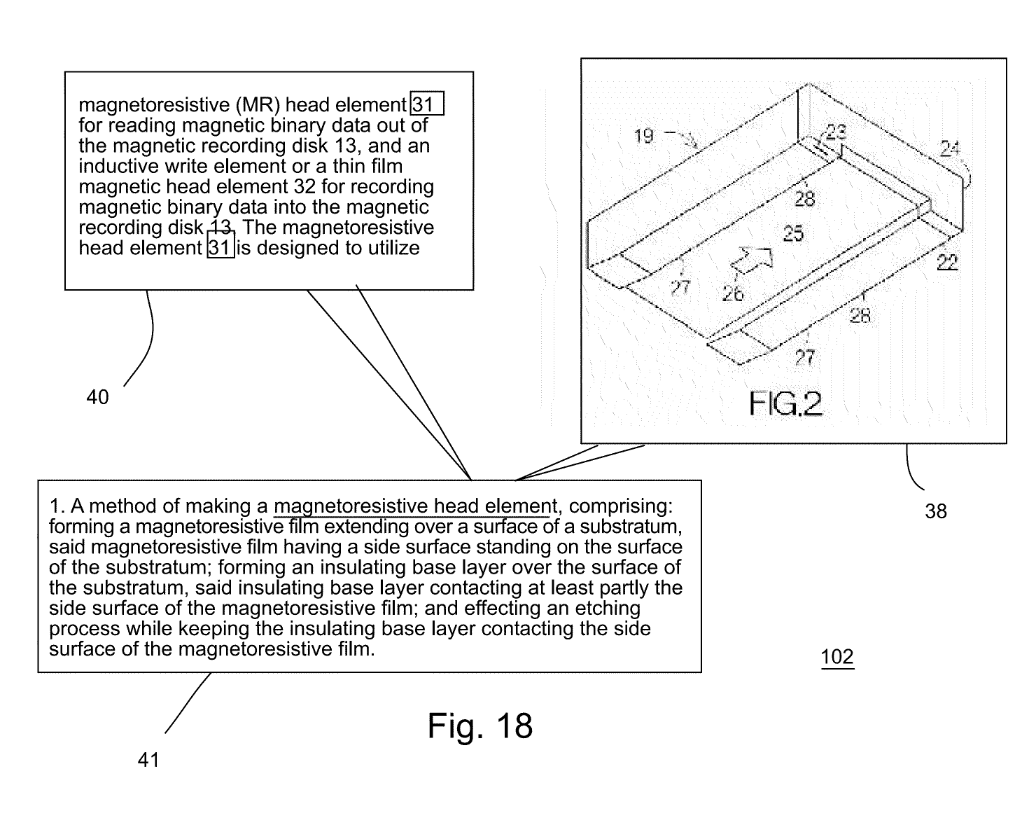

Referring to FIG. 18 a method of displaying a patent reference is shown, the patent reference having associated a) one or more drawings, b) a specification, and c) claims, in which a) and b) contain part identifiers, which are each associated with a part name in the specification, one or more of the part names having corresponding element names in the claims. Claims of the patent reference are displayed on screen 102. For each of one or more element names in the claims, such as element 31, a link is provided in association with the respective element name to one or more of flag, scroll to, or initiate a display event of one or more occurrences of the element name in i) the specification 40, ii) the part list 34, or both, on a user selection event of a respective link. Thus, as shown a user clicks on “magnetoresistive head element” and a pop up appears of an occurrence in specification 40. One or more of the drawings 38 may be displayed in conjunction with the claims. Part list 34 (not shown) may also be showed in conjunction with claims 41. The connections between claims 41 and specification 40 or list 34 may be made by first generating the list 34 by parsing the specification 40, and then looking for one or more words of each part name in the claims. For example, the algorithm may start by checking for the full part name, failing which words are removed one at a time from the left of the word, and the search repeated, until only the right most word remains. If a match is found the element name is flagged or noted for linking to a scroll to event. Similarly, links may be provided in the part list 34 for scrolling or displaying element names in the claims. During analysis the part names and claims may be standardized to remove all plurals or all singulars for the analysis. Each claim element may have multiple part names that might be the correct part name. Thus, on clicking on a claim element an option may appear to scroll specification 40 occurrences of each part name associated with the claim element.

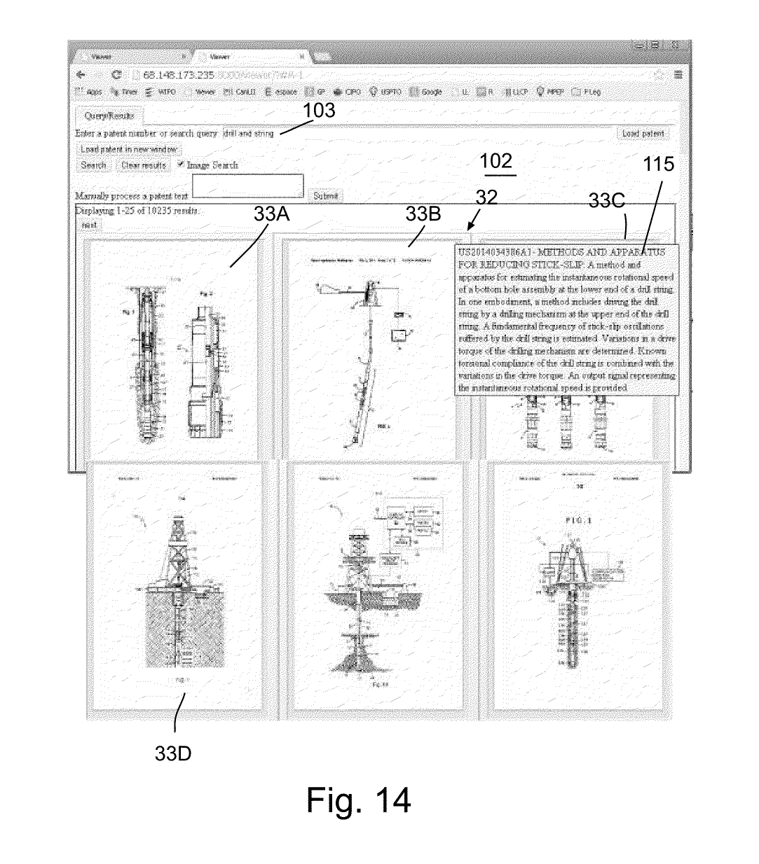

Referring to FIG. 14 a system 10 for searching a group of patent references is illustrated. A query form is shown on screen 102. In response to a user query event, a query is performed of a group of patent references. For example, keywords may be entered in search bar 103 and the search button clicked. A results list 32 is displayed of three or more patent references found in the query. The results list 32 comprises a sequence of drawings 33A, 33B, 33C, 33D, and others, which include one or more drawings from each of the three or more patent references. The drawings in the sequence are stacked horizontally and vertically adjacent one another on the one or more screens. For example, four patents might be stacked in a two by two table arrangement, or six as shown in a 3×3 arrangement. The appearance of the results may be similar to a mosaics image view, albeit with drawings from different patent references as opposed to multiple drawings from the same patent reference. Horizontal and vertical refers only to the arrangement on screen 102, and does not refer to the orientation of the screen 102 with respect to the earth. Thus, the image search presents visual information to the user in an efficient manner. An image search option may be checked for such a search as shown, as such a search may not be desired in all cases, such as chemical cases or cases where results are unlikely to reveal patents with drawings. The drawings in the sequence may border one another or fit within frames as shown that border one another. Bibliographic or other information may appear, for example in the form of a pop up 115 in response to a user selection event such as by hovering over a particular drawing.

Below is an example portion of a modified specification text taken from the specification of U.S. Pat. No. 7,123,456. The original or input specification has been modified to insert <span> wrapper markup elements around part name and part identifier combinations:

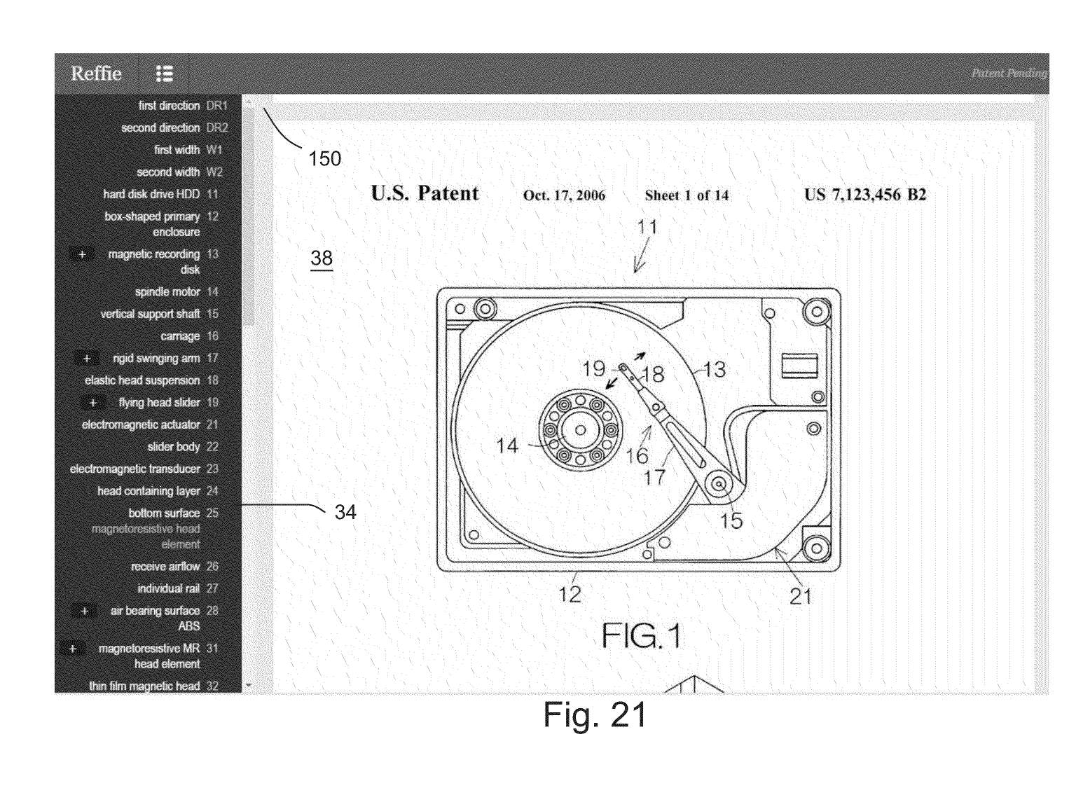

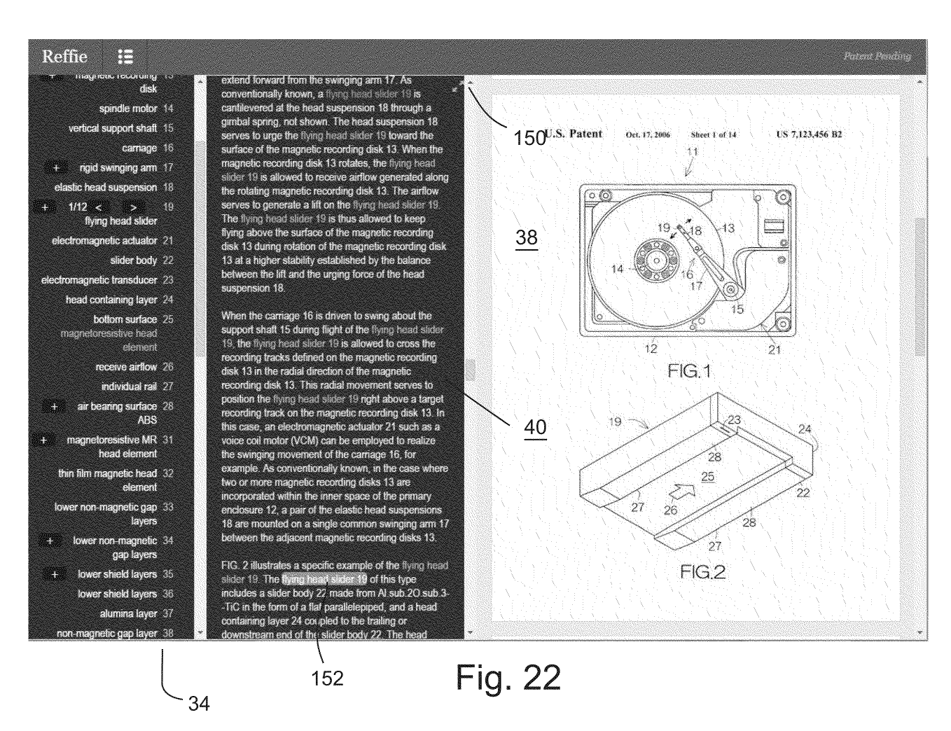

As shown in FIG. 21, the <span class=“US7123456part_67_00_00″>photoresist film 67</span> is
thereafter removed. An O.sub.2 plasma, a suitable photoresist stripper or stripping solution, and the
like, may be employed to remove the <span class=“US7123456part_67_00_00″>photoresist film
67,</span> for example. Formation of the <span
class=“US7123456part_31_00_01″>magnetoresistive head element 31</span> is accordingly
completed. Thereafter, the <span class=“US7123456part_33_00_00″>non-magnetic gap layer
33</span> and the <span class=“US7123456part_32_00_00″>thin film magnetic head element
32</span> are sequentially formed on the <span class=“US7123456part_31_00_01″>resulting
magnetoresistive head element 31</span> in a conventional manner. As shown in FIG. 22, an <span
class=US7123456part_68_00_00″>extra marginal section 68</span> is finally scraped in the <span
class=US7123456part_19_00_01″>individual flying head slider 19</span> during formation or
shaping of the <span class=US7123456part_25_00_00″>bottom surface 25.</span> When the <span
class=US7123456part_68_00_00″>extra marginal section 68</span> has completely been cut off, the
read gap of the <span class=US7123456part_25_01_00″>magnetoresistive head element 25</span> is
allowed to expose at the <span class=US7123456part_25_00_00″>bottom surface 25</span> in the
aforementioned manner.

As shown, in the specification excerpt above part identifiers are each associated with a part name having a set of one or more occurrences in the specification. Some sets have a plurality of occurrences. For example, part identifier 67 appears numerous times in the paragraph in question. In one stage of a method, the modified specification is stored on a computer readable medium, such as RAM on a user's computer 16 after being served to a user by a server. At least a portion of the modified specification is displayed on a screen. In other cases the modified specification is stored on the database 19 and portions served to the user as requested.

The modified specification may be produced by processor 18, computer 16, or another processor 18. The modified specification may be produced on an ad hoc basis, for example by the server or user's browser upon selection of a patent to load. In other cases the modified specification may be pre-generated in advance, by cycling through patent records in a patent database 19 and modifying and storing modified specifications. To create the modified specification the specification may be parsed with a processor to identify each part name and the modified specification produced by inserting the span tags as shown above. Although span tags are used, other wrapper markup elements or tags may be used such as other HTML or XML wrappers. For example, an <a>, <input>, <div>, <button>, or other HTML wrapper may be used. Alternatively, a custom XML or HTML element may be used, such as <part>. The text of the wrapper markup element is not itself displayed (ex. <a . . . > is not displayed) when the text is displayed in a browser, but the element provides the browser with information that may be used to access or manipulate the text contained or wrapped by the element (ex. “magnetoresistive head element 31” is displayed).

For each set of occurrences of a part name, each occurrence of the respective part name in the set may be adjacent to or contained at least partially within a respective wrapper markup element that is within the modified specification. For example, in the excerpt above and in the entire modified specification each and every occurrence of a part identifier and part name is wrapped by a span wrapper. Each such wrapper has a first wrapper identifier that is common to the set but distinct from the wrapper identifiers of the other sets. Thus, in the example above all occurrences of part identifier 68 are wrapped by a span with a class name of class prefix=US7123456part_{—}68_{—}00”. Similarly, all occurrences of part identifier 67 are wrapped by a span with a class prefix name of class=US7123456part_{—}67_{—}00”. The first wrapper identifier is a prefix in the examples shown, but may be a separate and independent class name. Although a “class” attribute is used to store the wrapper identifier as a property of the attribute, other attribute types, including custom ones, may be used such as “id”, “data”, or “name” attributes in the case of HTML elements. In other cases the name of the wrapper markup element itself may include the wrapper identifier(s), for example if the element is <US71234567part_{—}67_{—}00_{—}00> for the example above.

The one or more sets of occurrences may contain occurrences of variants of the part name. For example, in another portion of the modified specification not excerpted above, the first occurrence of part identifier 31 is associated with a part name of “magnetoresistive (MR) head element”. Thus, the part name of “magnetoresistive head element” is a variant of the first occurrence because the only difference is the dropping of the “(MR)” portion. The first occurrence could also be considered a variant of all variants of that part name as well. For each variant in a set of part names such as a set of the first and subsequent occurrences of the two variants discussed above, the wrapper markup element for the variant may have a second wrapper identifier. Each subset of a unique variant may have its own second wrapper identifier. The second wrapper identifier is common to the other occurrences of the variant but distinct from the wrapper identifiers and second wrapper identifiers of the other variants and the other sets. The second wrapper identifier may be contained in an attribute property that is independent from the attribute property of the wrapper identifier, also called the first wrapper identifier, which is common to the entire set of part names, including variants. Thus, the first and second wrapper identifiers may be defined as class=“US7123456part_{—}31_{—}00 US7123456part_{—}31_{—}00_{—}00”—in other words two class names, with the second identifier being the latter class name.

In other examples, including the one excerpted above, the wrapper markup element may have a combined wrapper identifier. The first wrapper identifier may comprise at least a first part, such as a prefix, of the combined wrapper identifier and the second wrapper identifier comprises at least a second part, such as a prefix and suffix, of the combined wrapper identifier. Thus, for example the first occurrence is wrapped as “<span class=“US7123456part_{—}31_{—}00_{—}00”> magnetoresistive (MR) head element 31</span>”, while the variant is wrapped as “<span class=US7123456part_{—}31_{—}00_{—}01”> magnetoresistive head element 31</span>”. The first identifier is common to both wrappers as “class=US7123456part_{—}31_{—}00”, while the wrapper effectively has the respective second identifiers of class=US7123456part_{—}31_{—}00_{—}00” and class=US7123456part_{—}31_{—}00_{—}01” respectively.

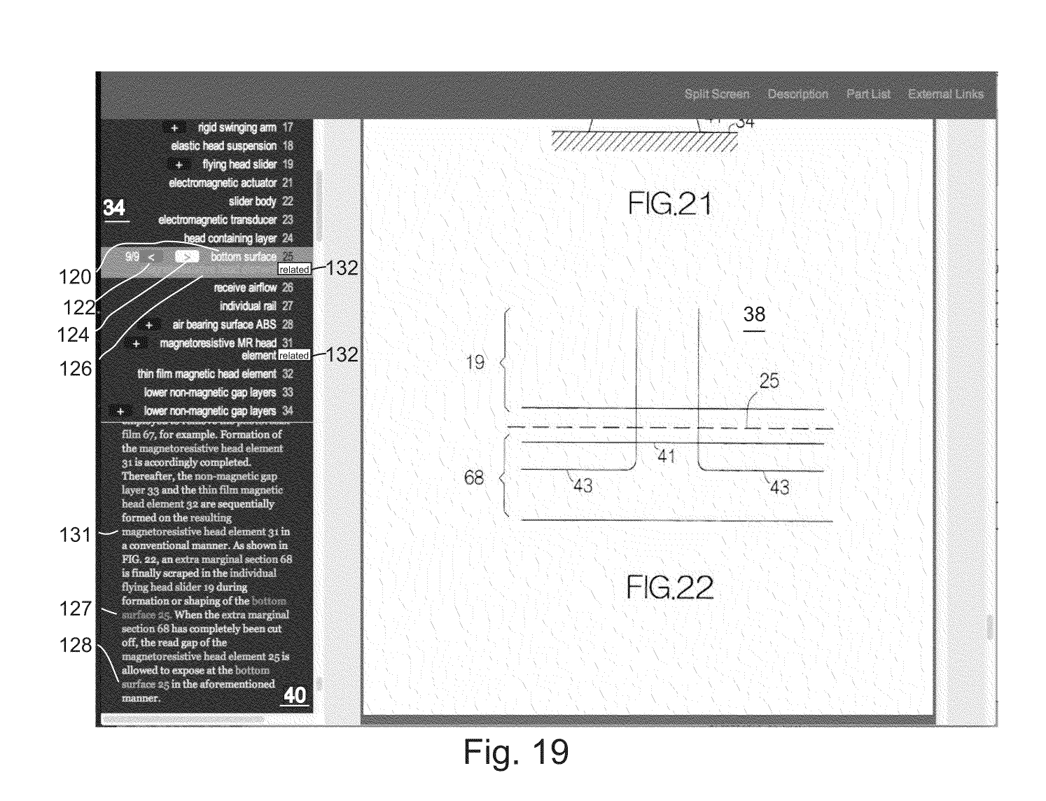

For each part name, part identifier, or combination of part identifier with associated part name, a link may be displayed. For example referring to FIG. 19, a further display is shown for a patent viewer. The part list 34 is shown with a list of the links, for example links 120, 122, and 124 associated with part name=bottom surface and link 126 associated with part identifier=25. The other part names shown in the list 34 are all associated with respective links to respective part names. The links use the respective wrapper identifier to one or more of flag, scroll to, or initiate a display event of, one or more occurrences, such as occurrences 127 and 128, in the set of one or more occurrences in the modified specification 40 for the respective part name, on a user selection event of a respective link.

Similarly, for each variant, part identifier, or combination of part identifier with associated variant, a variant link may be displayed in the list 34. The variant links may use the respective second wrapper identifier to one or more of flag, scroll to, or initiate a display event of, one or more occurrences in the set of occurrences in the modified specification for the respective variant, on a user selection event of a respective variant link.

The links, including variant links, may be set up in a suitable fashion for operation. For example, the display shown in FIG. 13B is set up with a table housing the elements of the list 34. The HTML code for the table row associated with part identifier 28 in the list 34 table is shown below.

```
<td align=″right″>
  <input type=″button″ id=″expand_US7123456part_28_00″ value=″+″ onclick=″return
dropdownvar(′dropdown_US7123456part_28_00′)″>
  <span id=″id_US7123456part_28_00_00″>
    <span class=″left_US7123456part_28_00_00″ style=″display: none; ″>
      <span class=″pos″></span>
      <input type=″button″ value=″&amp; lt;″ onclick=″return
findpart(′US7123456part_28_00′, ′left′, ′US7123456part_28_00_00′, ′−1′)″>
      <input type=″button″ value=″&amp; gt;″ onclick=″return
findpart(′US7123456part_28_00′, ′right′, ′US7123456part_28_00_00′, ′−1′)″>
    </span>
    <a href=″#US7123456-1″ id=″href_&amp; quot;US7123456part_28_00_00&amp; quot;″
onclick=″return findpart(′US7123456part_28_00′, ′right′, ′US7123456part_28_00_00′, ′−1′)″>air
bearing surface ABS</a>
    <div id=″US7123456part_28_00_count″ style=″display:none″>−1</div>
  </span>
  <span id=″id_US7123456part_28_00_01″ class=″dropdown_US7123456part_28_00″
style=″display:none″><br>
    <span class=″left_US7123456part_28_00_01″ style=″display: none; ″>
      <span class=″pos″></span><
      input type=″button″ value=″&amp; lt;″ onclick=″return
findpart(′US7123456part_28_00_01′, ′left′, ′US7123456part_28_00_01′, ′−1′)″>
      <input type=″button″ value=″&amp; gt;″ onclick=″return
findpart(′US7123456part_28_00_01′, ′right′, ′US7123456part_28_00_01′, ′−1′)″>
    </span>
    <a href=″#US7123456-1″ id=″href_&amp; quot;US7123456part_28_00_01&amp; quot;″
onclick=″return findpart(′US7123456part_28_00_01′, ′right′, ′US7123456part_28_00_01′, ′−1′)″>air
bearing surfaces</a>
    <div id=″US7123456part_28_00_01_count″ style=″display:none″>−1</div>
  </span>
</td>
<td valign=″top″>28</td>
```

In FIG. 13B the table row is shown in the unexpanded position, though a click on the “+” button 116 will launch a javascript function dropdownvar (shown after the table HTML code below) to expand the row to show the variant part name “air bearing surfaces”. The code shown here is written partially in JQuery, which is a javascript library, although other suitable code may be used including pure javascript or other browser or coding languages. The table row shown above may be generated by cycling through each part identifier, adding applicable rows as needed for part names, variants, and conflicting part names associated with that part identifier, and adding back and forward buttons 122, 124, links 120-126, and drop down buttons 122 as needed. Legitimacy indicators such as different colors (white for high level of legitimacy and red for low level of legitimacy, for example) based on display codes sent to the browser from the part list algorithm.

```
function dropdownvar(classtodrop){//shows/hides drop down list for part list - eventually move
this to a hover function
  if($(′span[class=′′′ + classtodrop + ′′′]′).css(′display′) == ′none′){
    $(′span[class=′′′ + classtodrop + ′′′]′).show( );
  }
  else{
    $(′span[class=′′′ + classtodrop + ′′′]′).hide( );
  }
}
```

The <a> link tags in the list 34 each call a javascript function called findpart responsible for initiating, in this case, a scroll to, display, and flag event. The word link is used in association with a traditional hyperlink <a> tag, but a link is understood to include a location displayed on the screen and programmed to receive a user command in order to perform an action. For example, an event handler may be used for a particular type of tag to catch user commands, such as clicks, over text contained by the particular tag. Below is a reproduction of the findpart function:

```
function findpart(partclass, direction, partid, currpos){//scrolls through partnames in the specification
  var front = partclass.indexOf(″_″)+1;
  var secretdivname = ″find″ + partclass.substring(0, front);
  var maxspans = $(′span[class\hat{ }=′′′ + partclass + ′′′]′).length−1;
  var currentpos = 0;
  var cp = parseInt(currpos);
  if (cp == −1){
    currentpos = parseInt($(′#′ + partclass +
′_count′).text( ));//parseInt(document.getElementById(partclass + ′_0_0′).innerHTML);
  }
  else {
    currentpos = cp;
  }
  var newpos = 0;
  if (currentpos == -1){
    //first click - go to first hit
    newpos = 0;
  }
  else if (direction == ″right″){
    if (currentpos < maxspans){
      newpos = currentpos +1;
    }
    else if (currentpos == maxspans){
      //go to the first occurrence
      newpos = 0;
    }
  }
  else if (direction == ″left″){
    if (currentpos > 0){
      newpos = currentpos − 1;
    }
    else if (currentpos == 0){
      //go to the first occurrence
      newpos = maxspans;
    }
  }
  //clear all highlights and hide left and right button for the last span searched, if different from
this one
  var lastspan = $(″#″ +
secretdivname).html( );//document.getElementById(secretdivname).innerHTML;
  $(″#″ + secretdivname).html(partclass);
  var maxprevspans = $(′span[class\hat{ }=′′′ + lastspan + ′′′]′).length−1;
  for (var i=0; i<=maxprevspans; i++) {//clear all previous highlighting - if changing the color
have to change the CSS at two places below, look for findpart references in css
    $(′span[class\hat{ }=′′′ + lastspan + ′′′]′).get(i).removeAttribute(″style″);//.style.color =
″#e0dfda″;//clear all previous highlighting
  }
  $(′span[class\hat{ }=″left_′ + lastspan + ′′′]′).hide( );
  for (var i=0; i<=maxspans; i++) {//highlight all spans in the new class
    $(′span[class\hat{ }=′′′ + partclass + ′′′]′).get(i).style.color = ″#d3593c″;
  }
  if (maxspans > 0) { //only show if more than one part
    $(′span[class=″left_′ + partid + ′′′]′).show( );
  }
  //update the hidden position indicator
  $(′span[class=″left_′ + partid + ′′′])′.children(″.pos″).text(parseInt(newpos+1) + ″/″ +
parseInt(maxspans+1));
  document.getElementById(partclass + ′_count′).innerHTML = newpos;
  var spantoscroll = $(′span[class\hat{ }=′′′ + partclass + ′′′]′).get(newpos);
  spantoscroll.scrollIntoView( );
  $(′span[class\hat{ }=′′′ + partclass + ′′′]′).get(newpos).style.color = ″cyan″;//active part color
  //adjust position so num isn't at top of screen
  var scrollpos = $(″#home-box-text″).scrollTop( );
  if (cp != −1){ //scroll the part list if we loaded findpart from a description click not a list click
    $(′#id_′ + partid) [0].scrollIntoView( );
  }
}
```

Thus, clicks on links 110 may operate as follows. In a normal mode of display where only the main part name “air bearing surface ABS” is displayed, a click on link 113 engages the <a> tag for that link and fires the associated onclick function that fires the findpart function for that link, telling the findpart function to go direction=“right”, i.e. move to a subsequent occurrence. The onclick function also tells findpart that the active wrapper identifier associated with the desired action is partclass=“US7123456part_{—}28_{—}00”. The active wrapper identifier may be the first or second wrapper identifier as desired. Sending an active identifier allows findpart to discern if the user wants to a) cycle through all occurrences of the part name, including variants (use the first wrapper identifier), or b) cycle through only the occurrences of the variant, in this case with suffix _{—}00 (use the second wrapper identifier). The second wrapper identifier associated with the desired action is also sent as partid=“US7123456part_{—}28_{—}00_{—}00”. In this case the second wrapper identifier is used merely to identify the proper id name of a span wrapper associated with the part name row clicked in the list 34 and that houses the left and right buttons 114 if more than one occurrence is present in the specification for that part name. Because the user clicked on the main part name shown, it is assumed that the user wants option a), so in this case the second wrapper identifier is ignored. The current position of occurrences in the text is sent as “−1” but this value is ignored for clicks on the list 34.

Findpart first gets the current position (index) of occurrence of the selected part name. Thus, if the user previously clicked on link 113 three times, the current position may be 2 (with the first click going to occurrence index=0, the next click going to occurrence index=1, and the third click going to occurrence index=2). The current position may reset if another part name or part identifier is clicked, or the system may store the current position in such cases as it does in the example described. In this case the current position is stored in a hidden div associated with the respective link and having an id=“US7123456part_{—}28_{—}00_count”, though this is not required and the current position may be taken by analyzing the specification and reading which occurrence is highlighted or shown in view or is the closest occurrence above the text shown in view for example. Findpart then generates a new index position, either 3 or if there are no more occurrences, 0 to go back to the first occurrence. If the direction is selected as left, the index is subtracted by one to go to a previous occurrence or the last occurrence if index=0.

Next, findpart clears all highlighting of occurrences that were previously selected. In the example given, a hidden div is used to store identification information for the last part clicked. The hidden div in this example has id=“findUS7123456”, with “US7123456” being a unique prefix assigned to all identifiers associated with the links and part spans of the particular patent shown. A unique prefix may be used to prevent conflict between multiple patents loaded by the viewer in the same browser tab, though this is not required and the prefix may be dropped to compress the data and display only one patent at a time in a browser tab. While clearing the highlighted occurrences findpart also hides any left or right buttons 114 that were previously made visible as will be described further elsewhere in this document.

Because the first wrapper identifier is a prefix of the class name attribute, findpart looks for the first wrapper identifier in the class name prefix and not the entire class name when modifying the properties of the desired spans. After clearing the previous highlighting, all of the occurrences with the first wrapper identifier in this case are highlighted in a different color (for example dark brown) and the active occurrence is made cyan and scrolled into view. In the example shown “home-box-text” is the name of the section in the HTML DOM (document object model) that contains the modified specification.

In the above-discussed example the occurrences can only be scrolled one at a time by clicks. This may not be ideal, for example if a user clicks an occurrence in the list 34, and then manually scrolls through numerous occurrences in the modified specification, and then wants to jump to a further occurrence that is two or more occurrences subsequent from the active selected occurrence. For such cases, findpart may be modified to check which occurrence is the next subsequent occurrence that is either displayed in the field of view of the specification pane 40 or is not in the field of view but is closest to the field of view. That selected subsequent occurrence may then be scrolled to as the active part. Navigation actions of part names in the specification may be tied to a url api (application programming interface) so that each part name click has a unique api suffix (like #part28_{—}00_{—}01) that permits a user to use the back and forward browser history buttons to go back to previous and subsequent part navigation actions. Instead of directly updating the style of each span in the specification as is shown, an attribute may be modified, for example to add or remove a class name, like “activepart”, such class name being linked in the style properties (CSS) associated with the page for manipulating the style properties of that span.

In some cases a user may want to scroll only the variants of a part name. Thus, in the example given a user may expand the list by clicking “+” button 116, which fires dropdownvar and makes “air bearing surfaces” visible for selection. Once the <a> tag is clicked for “air bearing surfaces”, findpart fires. This time, findpart is told that the wrapper identifier to look for is the second wrapper identifier, “US7123456part_{—}28_{—}00_{—}01”. Thus, occurrences of the main part name that are not associated with the second wrapper identifier are not highlighted and scrolled to. There may be a plurality of variants, and each variant may have more than one occurrence.

One or more part identifiers may be associated with two or more conflicting part names. For example, in the excerpt of the modified specification shown above, part identifier “25” is associated with both “bottom surface” and “magnetoresistive head element”. The latter is flagged in list 34 in a different color to indicate that it is a likely mistake, because such has one occurrence only with part identifier 25 and the same name is associated with another part identifier 31 so likely was supposed to bear part identifier 31. Each of the conflicting part names may have a respective set of occurrences in the modified specification. For each set of occurrences of a conflicting part name, each occurrence of the respective conflicting part name in the set may be adjacent to or contained at least partially within a respective wrapper markup element that is within the modified specification and has a wrapper identifier that is common to the set but distinct from the wrapper identifiers of the other sets. Thus, in the example given above, the main part name “bottom surface” has a first wrapper identifier of “US7123456part_{—}25_{—}00” (prefix), while the conflicting part name has a first wrapper identifier of “US7123456part_{—}25_{—}01”. The latter two digits in both first wrapper identifier are index numbers, so more than one conflicting set of part names may be present with incrementally larger index numbers to organize the sets. Each set of conflicting part names may have variants as well, which may be dealt with in the same fashion as variants of the main part name.

For each conflicting part name, part identifier, or combination of part identifier with associated conflicting part name, a link 126 may be displayed in the list 34. Link 126 may use the respective wrapper identifier, in this case “US7123456part_{—}25_{—}01” to one or more of flag, scroll to, or initiate a display event of, one or more occurrences in the set of occurrences in the modified specification for the respective conflicting part name, on a user selection event of a respective link.

The HTML code for the table row associated with part identifier 25 in the list 34 table is shown below.

```
<span id=″id_Part_25_00_00″>
  <span class=″left_Part_25_00_00″ style=″display: inline; ″>
    <span class=″pos″>9/9</span>
    <input type=″button″ value=″&amp; lt;″ onclick=″return findpart(′Part_25_00′, ′left′,
′Part_25_00_00′, ′-1′)″>
    <input type=″button″ value=″&amp; gt;″ onclick=″return findpart(Part_25_00′, ′right′,
′Part_25_00_00′, ′−1′)″>
  </span>
  <a href=″#US7123456-1″ id=″href_ &amp; quot;Part_25_00_00&amp; quot;″ onclick=″return
findpart(′Part_25_00′, ′right′, ′Part_25_00_00′, ′−1′)″>bottom surface</a>
  <div id=US7123456part_25_00_count″ style=″display:none″>8</div>
</span>
<span id=″id_Part_25_01_00″><br>
  <span class=″left_Part_25_01_00″ style=″display: none; ″>
    <span class=″pos″>1/1</span>
    <input type=″button″ value=″&amp; lt;″ onclick=″return findpart(′Part_25_01′, ′left′,
′Part_25_01_00′, ′−1′)″>
    <input type=″button″ value=″&amp; gt;″ onclick=″return findpart(Part_25_01′, ′right′,
′Part_25_01_00′, ′−1′)′><
  /span>
  <a href=″#US7123456-1″ id=″href_&amp; quot;Part_25_01_00&amp; quot;″ onclick=″return
findpart(′Part_25_01′, ′right′, ′Part_25_01_00′, ′−1′)′ class=″listillegit″>magnetoresistive head
element</a>
  <div id=US7123456part_25_01_count″ style=″display:none″>0</div>
</span>
```

Because the first wrapper identifiers for “bottom surface” and “magnetoresistive head element”, both associated with part identifier 25, are distinct, findpart does not flag or scroll to the one when the other is clicked. For example, when the latter is clicked, findpart is told that the first wrapper identifier is “US7123456part_{—}25_{—}01”, and only those such occurrences are scrolled to and flagged. Because “magnetoresistive head element” is a likely mistake, it is given an additional class name “listillegit” to signal the CSS to display this element in a different color to show the user that it is a likely mistake. However, because the latter is a totally unique name associated with the part identifier, it could still have useful information for interpreting the drawings, and thus it may be displayed in the normal mode of operation below the main occurrence instead of being hidden.

As discussed elsewhere in this document the modified specification may contain one or more red herring terms that are each equivalent to a respective part identifier but are not associated with the corresponding part name. For example, in the excerpt shown above “Fig.” is a red herring for identifier 21, because “Fig.” is not intended to be a part name associated with the part identifier 21, which itself is associated in U.S. Pat. No. 7,123,456 with part name “electromagnetic actuator”. Thus, for each set of occurrences of a part name associated with a part identifier equivalent to one or more red herring terms, the respective wrapper identifier used for flagging, scrolling, or displaying, for the set is distinct from the wrapper identifiers, if any, associated with the one or more red herring terms. Thus, the first wrapper identifier used for “electromagnetic actuator” is “US7123456part_{—}21_{—}00” and “Fig.” in the example shown has no wrapper identifier. Because “Fig.” refers to a figure in the drawings, it may be wrapped by a markup element, and if so it will be given a wrapper identifier unique from all other first and second wrapper identifiers to avoid confusion. For example, “Fig.” may be given a wrapper identifier “US7123456fig_{—}21”.

Referring to FIG. 19, clicks on part name links in the modified specification 40 itself may cause an action to occur that affects the display of the modified specification, and in some cases the part list 34 as well. Thus, within the specification, for each identifier, name, or combination of name and identifier, a link, such as link 131 in the case of the part name associated with part identifier 31, may be provided, adjacent to or as part of the identifier, name, or combination of name and identifier, for example wrapped around the name and part identifier of a particular part. The location of a part in the modified specification 40 may be brought to the user's attention for example by a display event such as highlighting the part 152 when the user hovers over a part. The link 131 may be provided to one or more of flag, scroll to, or initiate a display event of, one or more occurrences in the specification 40 of the respective identifier, name, or combination of name and identifier, on a user selection event of a respective link within the specification 40. In order to use the modified specification with the wrapper markup element format discussed above, an event handler may be provided to capture and use clicks on the span elements. An example event handler is shown below for javascript (using JQUERY). Thus, in FIG. 22 a user may click on part 152 to scroll to the next occurrence of that part, and in some cases the list 34 may be scrolled to display the name for the part 152. Links may be provided for all parts in the specification, not just the active part that was initially clicked on from the list 34, so that a user reading the specification may simply traverse to the next location of a part that the user comes across, without having to select that part from the list.

```
$( ″#description span″ ).on(′click′, function( ) {
  var aclass = $(this).attr(′class′); //get the class of the span clicked
  var back = aclass.lastIndexOf(″_″);
  var classtosend = aclass.substring(0, back);
  var index = $(′span[class\hat{ }=′′′ + classtosend + ′′′]′).index($(this));
  var back = aclass.lastIndexOf(″_″);
  classtosend = aclass.substring(0, back);
  var partid = classtosend + ″_00″;
  return findpart(classtosend, ′right′, partid, index);
});
```

The #description reference in the event handler means that the event handler only fires for spans that occur in the div with id=description, which in this example is the div containing the modified specification in the example shown. First the function gets the first wrapper identifier of the wrapper markup element clicked. Then, the handler checks what index number the selected element has in the set of elements that share the same first wrapper identifier. The function assumes that the first wrapper identifier is the prefix of the class name in this example. The index number might be 3 if this is the fourth occurrence in the specification. Next, the handler calls the findpart function, and in contrast to clicks on the list 34, sends the index number. Because the findpart function receives the index number as the current position, the findpart function calculates the next position based on the index number, so in this case 4 if a fifth occurrence exists, or 0 if it doesn't. In other cases the function may find the next occurrence that is not visible in the displayed pane of specification 40. The function may also scroll the list 34 to where the same part identifier is shown, as is done in the last part of the findpart function. In the example above all part names and identifiers are wrapped with a wrapper markup element, so that clicks on all such part names and identifiers will cause scrolling and highlighting. Such a feature is useful for scrolling between spaced series of part names, for example if the same part name is discussed in a first section and a second section of the specification, the first and second sections spaced from one another. Rather than going back to the list 34 to scroll to the next part after reading the first section, the user can just click on the part in the specification to achieve the same goal.

In some cases the specification 40 includes claims and a description, and in which, within the description, for each identifier, name, or combination of name and identifier, the link is provided, adjacent to or as part of the identifier, name, or combination of name and identifier. The link may one or more of flag, scroll to, or initiate a display event of, one or more occurrences in the description of the respective identifier, name, or combination of name and identifier, on a user selection event of a respective link within the description. Thus, the link 131 may only cycle occurrences in the description. Occurrences in the description tend to provide more useful information about a part for the purpose of understanding what the drawing describes than do occurrences in the claims. Similarly, the links may only be provided to cycle through occurrences in the detailed description, as opposed to the summary, which usually parrots the claims and is thus less useful. Such may be done by cycling through occurrences of part names associated with part identifiers, as part names tend to only appear in the detailed description with part identifiers, and rarely in other parts of the specification with part identifiers. The background information and brief description of the drawings sections may be coupled to the detailed description for the purpose of such linking.

In the example given above scrolling to only subsequent occurrences of a part is provided. However, each link 131 may have an associated second link that is provided to scroll to a previous occurrence in the specification of the respective identifier, name, or combination of name and identifier, on a user selection event of a respective second link within the specification. For example, a back button “<” may be provided adjacent each part name or identifier. The back button “<” may be provided adjacent a forward button “>”. Clicks on the back button may use findpart by getting the markup element index, and telling the findpart function to look direction=“left”. To avoid cluttering the specification, a user selection event of a respective link 131 may make visible one or more respective second links in the specification, so that the back button “<” for a set of occurrences only appears when one of the links 131 in the set is clicked. Other mechanisms may be used for such a purpose. For example, a first portion of the part name may be linked as a back button, while a second portion of the part name may be linked as a forward button. For example, if the part name is “head element”, clicks on “head” may go back while clicks on “element” may go forward. Or the division may be drawn roughly halfway through the number of characters in the entire part name. The same system may be used for links in the list 34. When the part name or identifier is hovered over, “<” and “>” characters or other suitable images may appear to intuitively direct the user to understanding how clicks on either portion will be interpreted. The images or characters of back and forward buttons may appear partially transparent so the original text can still be read (ex. < and > overlaid over a part name so that both the <, > and part name can be read simultaneously).

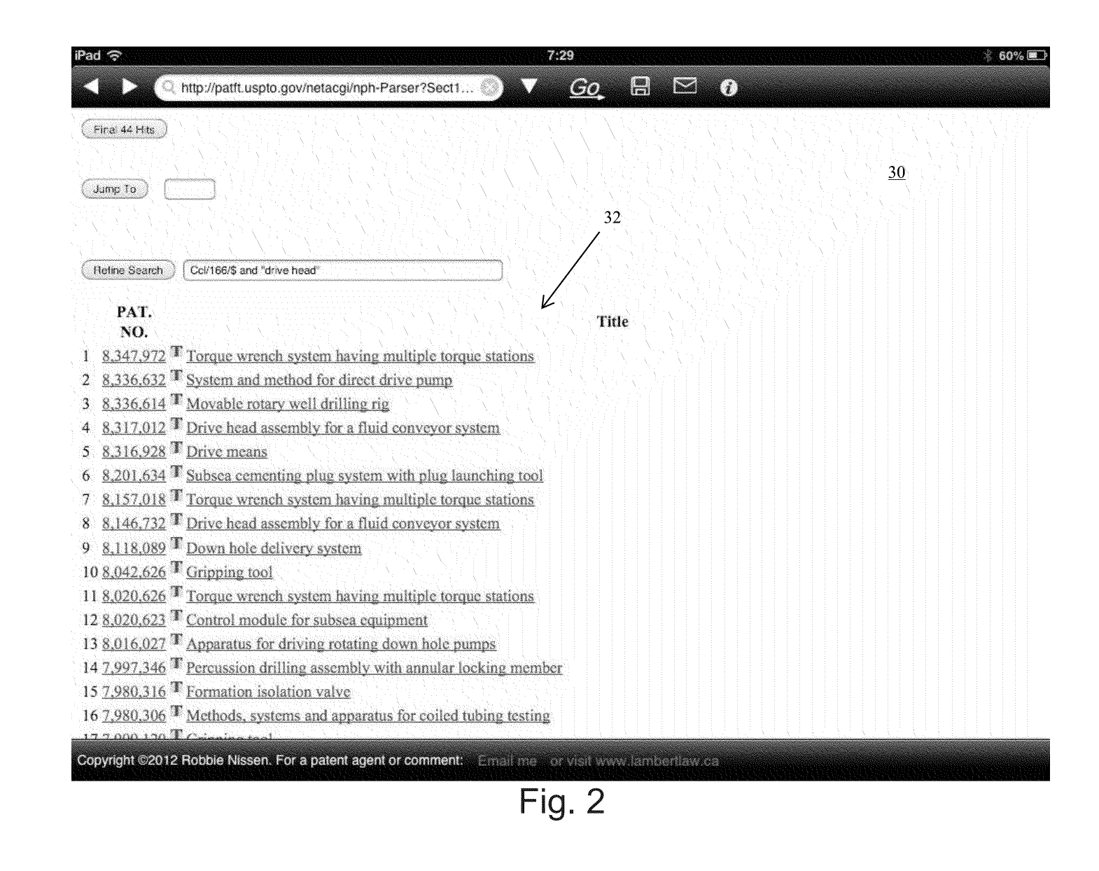

The in-specification links described above may be associated with each figure number as well, so that sets of occurrences of each figure number may be navigated. For example, by clicking on FIG. 2 the display may scroll to the next occurrence of FIG. 2. When a name such as a part name or figure identifier are hovered over, the contents of the markup element may be highlighted to signal to the user that the element can be clicked.

As eluded to above, each part name, identifier, or combination of both may have a dedicated set of forward and backward buttons for the purpose of scrolling the specification 40. FIG. 13B illustrates an example of one such set of buttons 114, which will only work for navigating the part associated with part identifier 28 and not other parts, including variants, shown in list 34. The forward and backward links 114 are adjacent the respective part in the list 34. Such links 114 offer better functionality than a global set of back and forward buttons that operate with any selected part, because in the example given a user who has clicked on a part to find the part in the specification need only move the mouse or finger a short distance or no distance to the adjacent buttons 114 to leverage the functionality of buttons 114 instead of navigating to a global set of buttons. The back link of buttons 114, or one or both the back and forward links of buttons 114, may be displayed on one or more of a user selection event of a respective forward link or as part of displaying the list of part identifiers 34. Thus, the list 34 may be initially displayed with each set of respective buttons 114 visible for selection. Or the list 34 may appear in an initial state with no buttons 114 appearing, and then on a selection of a part the back button or both buttons 114 appear. The buttons 114 may be hidden but defined in the DOM in a normal mode of operation, only to become visible when a part is selected. Or the buttons 114 may be created only when the part is selected. The forward link of button 114 may be always visible, for example if the forward link is the link associated with the part, and only a back button 114 appears on selection. Adjacent in this document may mean displayed in the same row as, so that the buttons 114 are in the same row as part identifier 28 in the example shown. Adjacent may also mean directly to the side of.

Referring to FIG. 19 each set of occurrences of a name, such as a part name, associated with an identifier such as a part identifier, may have related names and identifiers in the specification. Thus, in the excerpt shown above “magnetoresistive head element” is a first name associated with a first part identifier 31, and “magnetoresistive head element” is a second name associated with a second part identifier 25, the second name being related to the first name and vice versa. For each first name, first identifier, or combination of first identifier with associated first name, a link, such as a “find related” button 132 may be displayed to one or more of flag, scroll to, or initiate a display event of, one or more related names, second identifier, or related name and second identifier on a user selection event of a respective link. For example, a click on button 132 may scroll the list 34 to head element 25, which itself may have a find related button. The find related button of 25 may then scroll the list 34 back to 31 in the list 34 or to a subsequent related name. Clicks on find related may also scroll the specification 40, for example if find related button 132 is clicked the specification may fire findpart as if head element 25 was clicked in the list 34 or specification, or may find the first occurrence of head element 25.

An option may be given to associate head element 25 with head element 31 in the list 34 so that clicks on the head element 31 or 25 will scroll and flag occurrences of head element 31 and head element 25, as an act of updating the list 34. Finding related part names is useful particularly when there may be plural embodiments that use the same part names but different part identifiers, for example if there was a head element 31 in a first embodiment and a head element 131 in a second embodiment. A user may desire to scroll all of these occurrences. The find related button 132 may only appear when there are related part names, so may not appear for the other parts displayed in the list 34 for FIG. 19.

Identifying related part names may be carried out in a fashion similar to the way that the part list algorithm decides if a part name is a variant or repeat of a previously used part name. Thus, in one case related part names are names that have at least one common word. In another, the related part names may have at least the same right most word, such as “element” in the example discussed above. The check of same words may normalize the words to avoid plural or singular form from given a false negative match on words like “seasons” and “season” for example.

Referring to FIG. 16, the “Parts shown in the drawings” field 108 may be called “Drawings” or “Search the drawings” or another suitable title. In one case, field 108 may be associated with searching an index of a combination of lists of part names and one or more of titles and abstracts, the lists and one or more of titles and abstracts being stored on a computer readable medium such as database 19 or processor 18. In response to a user query event, a query may be performed, using text in the text entry field 108, of the index. In one case the index for field 108 includes the part list, abstract, and title. Thus, a hit from a query for words A, B and C may include a patent with word A in the title, word B in the abstract, and word C in the part list, or A, B in the abstract and C in the part list, or ABC in one field, as examples. A results list 32 of one or more patent references found in the query may be displayed. By contrast searching an index of part lists only is useful but may exclude patent references whose subject is a particular item, like a “tubing drain”, but that do not actually use the item's name in the drawing because the application focuses instead on the name of parts of the “tubing drain”. Adding the title and abstract may assist in ensuring that such references are not missed in a search for items in the drawings, as the title and abstract are likely to include elements shown in the drawings.

The part list may be emphasized in the index of part list, and one or more of title and abstract. Instead of just a list of the part names, the part list used to form the index may instead include a text block of all occurrences of each part name with words separated by a separator like a space and part names separated by a separator such as a space or period and space or line break and space, or comma and space, or other suitable separators. Occurrences may appear in the order they appear in the specification relative to one another, so that proximity relationships between different parts are preserved. A text block permits the search engine to take into account the relative term frequency among parts. The part names in the block may be arranged so that parts appear in the order they appear in the text, so that the block is roughly equivalent to the specification with all non-part names and stop words removed. The block may be compressed, for example by selective deletion of occurrences. For example, it may be an unnecessary usage of storage space to index a block with part A in six occurrences and part B in four occurrences, when the block could instead include part A in three and part B in two occurrences. This can be done without deletion of entire part sets, for example parts of one occurrence remain at one occurrence, parts of two occurrences have one occurrence deleted, parts of three occurrences have two of three occurrences deleted, and parts of four or more occurrences have three of four occurrences deleted. Such a compression method results in a term frequency reduction of 0-25% with increasing reduction with increasing original term frequency (term frequency understood as being calculated by number of occurrences of a word or phrase divided by total words or phrases in the specification). However, reductions in block size from the modified specification are on the order of ¼ to ⅕ the original size, thus leading to a smaller and more efficiently searchable index. The first occurrence may always be left undeleted in the block. The title may be emphasized in the block by placement at the top of the block, and redundancy added, for example the title may be duplicated ten times. The title may also be added after compression of the part list block and/or after compression of the part list block and abstract. In other cases the title, part list, and abstract blocks may be separate blocks, and may be collectively searched in the same manner described above by a multi-match query that treats the blocks as if they were one block. In such a case hits in the title may be field boosted to achieve the same emphasis effect.

The compression methods described here may increase noise slightly by reducing the ratio of occurrences of highly frequent parts to less frequent parts. However, in most cases the most important parts may appear in the specification one hundred times or more, and the above mentioned compression method would reduce these occurrences to twenty five, which compared to the plethora of single appearance parts, would still give a term frequency ratio of twenty five to one. Compression is useful because it cuts down the amount of storage space required for the index, while retaining the relatively high keyword frequency of important parts. The relationship between different parts is also retained to a degree. For example, if parts A and B occur twenty times each in a patent, and in the same paragraphs, the above compression method will still retain occurrences of parts A and B in close proximity, thus permitting a proximity search method to find the patent. Some information will be lost but speed will be gained. The title and abstract in the block may also be compressed as described here. Compression may be done on a word by word basis (ex. deletion of ¾ of each “element” word) or on a part by part basis (ex. deletion of ¾ of each “magnetoresistive head element” name as such appear more than 4 times).

Other compression methods may be used, for example by determining the highest occurrence part, permitting that part to appear in the text block X number of times, for example fifty times, and scaling back the occurrences of all other parts in proportion. Thus, if a part list text block has part A=100 occurrences, part B=25 occurrences, part C=2 occurrences, and part D=1 occurrence, the above described weighting method will result in a text block with part A=50 occurrences, part B=12 occurrences, and parts C and D=1 occurrence.

In general, the compression methods used on the part list text block may be used to index text or data of any type from the patent application. For example, the specification, including claims and abstract may be indexed from a text block that is compressed. As well, the abstract used with the part list block above may itself be a compressed block of text. The text block may first include the raw text. Then, removed are numbers and wrappers, if any, as well as irrelevant non alphanumerical characters like : and ; and (and). Then, irrelevant words like “also”, “here”, and other stop words are removed. Then, the remaining block of text is compressed, and then indexed. The text block may have added to it a compressed or uncompressed block of parts as described above.

Referring to FIG. 17 a further searching method may be carried out to identify patent references related to a selected patent reference or group of patent references. For example, a button 134 may be clicked from a compare interface, such as a patent display as shown, with an identifier, such as a patent number, of a source patent reference from the group of patent references, to launch the search method. Thus, in the example shown clicking on button 134 will look for patent references like U.S. Pat. No. 4,699,117. On button 134 click a comparison may be carried out, between a list of part names associated with the source patent reference, and lists of part names stored on a computer readable medium, for example database 19. Each list in the list of part names is associated with a respective patent reference of the group of patent references. After the comparison a results list such as that shown in FIG. 16 may be displayed to list the one or more patent references found in the comparison.

The comparison may be carried out using a more like this algorithm, for example a more like this algorithm offered by the ElasticSearch or SOLR lucene-based backends. One way to carry out the comparison is to start with the part list for the source patent, including information as to term frequency such as a list of the number of occurrences for each part. The goal may be to generate a query to use on the patent database. Parts with less than X frequency, for example less than 5% TF (term frequency), may be excluded from the generated query. Parts with more than X frequency may be added to the query. A max term limit may be imposed on the query, so that only Y number of parts appear in the query, with the parts with highest frequency taking precedence over parts of lower frequency.

Further properties for the query may be defined. For example, the query may match patent references in which Z % or more of the terms in the query are matched. The query may also have a minimum document frequency, for example 5, so that if five or less documents are found for a particular term in the query, that term is ignored. By converse, a maximum document frequency may also be defined, so that if more than J % of documents have a particular term, that term is ignored as being too common A minimum and maximum term length may be defined, so that terms with lengths outside the range are ignored, for example “be” may be ignored if the cutoff is words of three or more characters. A semantic mechanism may be carried out on the query to generate synonyms in some cases. Properties may be user adjusted.

For some cases where part names have multiple words, and multiple variants, the query may search for different variations of the part name. For example, if a part has name XYZ where X, Y, and Z are words, and the part has variant names YZ and Z used in the text, the query may take the portion dedicated to XYZ and split it up as find(XYZ) OR find(YZ) or find(Z). Boosting may be applied in order of increasing boost for larger words, so that XYZ is boosted in one case while YZ and Z are not or while YZ is boosted less than XYZ but more than Z.

The part list used as raw data for the query may include non-part element names from the text. For example, the non-part element names of highest TF may be included. Thus, in the example shown “cross bow” has the highest TF in the displayed patent, though it is not a part in the part list, yet it appears in the selection list 135 for the more like this algorithm. The list 135 also includes parts in order from highest to lowest TF, and has the highest four parts auto selected. Non part element names may also include names found in the title or abstract, as such are more likely to be general names of objects in the drawings, yet too general to be named as individual parts in many cases as in the one here.

In the above case the query is generated using the part list as raw data, and in another case the raw data may be created by displaying the part list to the user for selection of individual parts. The part list may be ordered by part identifier, term frequency, or by other suitable sort methods. The parts selected by the user for analysis in the query may then be subjected to the more like this algorithm. In other cases the parts selected by the user may be run directly in a search engine to find similar patents. In some cases the system may pre-select all parts or the most popular parts that the user previously clicked upon in the part list while viewing the source patent.

The comparison methods may use term frequency-inverse document frequency (TF*IDF) based relevancy determination, but other methods may be used such as K-Means or Bayesian Naïve.

Once generated the query is carried out on the part list field index from the patent database, and results returned. The results ideally will show similar elements in the drawings as shown in the drawings of the source patent reference.

In one case the comparison is carried out between a) the part list and one or more of the title and abstract associated with the source patent reference, and b) the part list and one or more of titles and abstracts stored on the computer readable medium and each associated with a respective patent reference of the group of patent references. Thus, as described elsewhere, the theory may be that the abstract, title, and part list all are likely to contain information on what is shown in the drawings, and hence all such fields may be compared. The extraction of a query from the title, abstract, and part list may be carried out in a fashion similar to that described above for the extraction of a query for the part list.

A user selection of a link may include events other than a click. For example, in one case discussed elsewhere a hover may be such a selection. In other cases a scrollbar movement may be such an event, at least when combined with another event like a hover to indicate that the user wants to tie the scroll wheel or other scroll event to a particular part. For example, a user may hover the cursor over a part in the list 34, and then move the scroll wheel to cycle through occurrences in the specification 40 pane. Such functionality may also be carried out when a user hovers over a part in the specification 40 and initiates a scroll wheel action. In other cases, merely hovering over a part in the list 34 will scroll the specification 40 to the first or next occurrence of the part in the specification 40. The system may store a user selected location in the specification, for example a scroll position manually scrolled to, and when the user hovers over a part in the list 34 the specification 40 is scrolled to that part, and when the user moves off the part the specification 40 may scroll back to the user selected location.

Referring to FIG. 13A, a patent may be opened in an in app tab 117, or as a new window in the browser 119. Loading references in new windows or tabs allows a user to review a new reference without modifying the search results page. Query terms may be pre-processed for example to remove plurals and standardize case status, such as uppercase only. When an item such as one or more drawings are indicated as being displayed, it should be understood that only a portion of the item need be displayed. Updating of lists 34 may be crowd-sourced by customers of the system or may be used by employees of the data provider to update the lists, in which case screening of list updates may be reduced or eliminated. In some cases to save space the parts lists may be generated only at indexing time for the search engine, so that such parts lists 34 do not take up space in the database. In some cases part name includes variants of the part name, such as all variants and the main name falling under the rubric of the main part name. Search methods discussed here may include Boolean searches, exact match searches, semantic searches, heuristic searches, and other conventional search types. A semantic search is understood to find hits that may not necessarily contain any query terms but are established by other reasons to be relevant. Depending on context a database may include an index or a table in a database. On a user selection any property of the wrapped part may be altered, for example a sound or display style. Style changes may be accomplished by adding or removing an attribute property, such as a class name, with respective attribute properties being identified by CSS in association with different display properties. Thus, the class name “hidediv” may be associated in CSS with a hide function. A list of figures, like the list 34 of part names, may be displayed, with functionality similar to that of list 34, in which clicks on figures in the figure list scroll to occurrences of that figure in the specification. A text box (not shown) may be used to search the part list, or only part names identified in the specification (and not red herring terms or same name terms that are not associated with a part identifier or validated as an occurrence of the part name. The text box may also search for part identifiers, thus excluding red herring identifiers like dates or amounts. Links include buttons, hyperlinks, hover events, and other suitable linking mechanisms. Cycling occurrences on successive clicks may include cycling groups of occurrences for example cycling to the next pane view with visible occurrences, as opposed to cycling through multiple occurrences in one pane one at a time. References to the specification include references to portions of the specification.

For abstract searching in the embodiments disclosed herein, the abstract of OCR patent references or other patent references that do not have an abstract provided with the data, an abstract may be auto-generated by taking a text block starting X characters into the specification and terminating Y characters after the X character start. Thus, for example an auto generated abstract may start 200 characters in and terminate at 1000 characters. Thus, the abstract is extracted from an initial portion of the specification. Such a location often denotes an actual abstract or a discussion akin to an abstract, for example a global overview of the technology discussed in the patent reference.

The list 34 or links in the list 34 or specification may be tied to occurrences of the part name in sections like the claims or summary, even though such may not be associated with part identifiers. In such cases, the occurrences lacking part identifiers may be scrolled to after all occurrences in the description portion of the specification are scrolled through. Thus, a click on the list 34 may cycle the background info, brief description of the figures, and detailed description for hits associated with part identifiers. Afterwards, clicks on the part in the list 34 or specification 40 may cycle to the claims or summary Thus, a click on head element 31 will cycle through all occurrences associated with 31, and then cycle to occurrences of head element in the claims and summary not associated with 31. Other sections may be checked. The list 34, and modified specification in some cases, may be transmitted to a user's browser or to the server in a suitable format such as a json list with list names, list numbers, wrapper identifiers, and modified specification.

Wrapper identifiers may be added in a suitable fashion. For example, during parsing a part name may be validated, since it is followed by a part identifier and satisfies certain constraints discussed above (doesn't contain stop words, etc). At that point a generic wrapper markup element may be wrapped around the part identifier, part name, or combination of both. The wrapper markup element may be generic, for example it may be US7123456part_{—}31_{—}00_{—}00 even for conflicting part names and part names. The character offset of the suffix, for example 00_{—}00 in the example, is kept in memory for use later in the algorithm. Then, once the entire specification is parsed, and all parts identified and wrapped, conflict resolution begins.

During conflict resolution for each part identifier part name sets are identified and associated with the final suffix for each wrapper identifier. Thus, for part identifier 25 “bottom surface” is found to be the main part name, and “magnetoresistive head element” a conflicting part name, and each are given different suffixes. The generic suffixes of each occurrence are swapped with the final suffixes, so that the former gets 0000 and the latter gets 0100, assuming no variants for either part name. If variants are present the latter portion of the suffix gets updated accordingly (_{—}00 for the first variant, _{—}01 for the second, etc). The character offsets are dropped at this point, and each part name stored in the list is associated with an identifier that is either equivalent to the specific wrapper identifier of that part (ex US7123456part_{—}25_{—}00_{—}00) or has enough information that the wrapper identifier of that part can be generated (ex. 25_{—}00_{—}00 if the prefix US7123456 is stored elsewhere). In other cases character offsets may not be needed as the final suffixes may be added by doing a find and replace for generic wrapper identifiers, with some analysis to ensure that the correct suffix is added for a particular part (ex. all US7123456part_{—}25_{—}00_{—}00 may be cycled through, which might include conflicting part names, and then for each hit, the specification may be parsed back to identify if the part name in question is a conflicting or main part name, and then the proper final suffix added as desired). In other cases instead of a generic wrapper identifier a unique or final wrapper identifier may be added on the fly. The final output of the algorithm may be a combination, such as a tuple, of part identifiers, part names, wrapper identifiers, and display codes for each part name.

Conflict resolution may occur as follows once the specification has been parsed. For each part identifier where a single part name is used, the legitimacy of the part name is estimated by for example the number of occurrences and whether or not a preceding word is used to define the name. If either condition is satisfied the single part name is given a display code of legitimacy, if not it may have a display code of low legitimacy. For each part identifier having two or more part names, the part names are cycled one or more times to organize into sets of unique part names, each set including variants. On a first cycle the looper assumes that the first part name is the first occurrence, and compares all subsequent parts to the first occurrence. If a common word is found between the first and subsequent part names, the subsequent name is flagged as a variant of the first occurrence. If not, the subsequent occurrence is flagged as a conflicting name. After the first cycle the first occurrence and variants are given wrapper identifiers that match all as part of the same group (first wrapper identifier), and each variant has a unique suffix (second wrapper identifier). Next the remaining conflicting part names, if any, are cycled using the same algorithm. Once again the first conflicting part name is considered the first occurrence, and all variants of that name are flagged as being associated with that first occurrence, and tags are assigned to match all together in the same fashion as done with the main part name. The cycling is repeated until there are no more part names left to review. Tags are then updated in the specification at this point or at another suitable point in the process. In some cases, after the cycling but before tag replacement, the algorithm may replace the main part name with a set of conflicting part names if that set shows some legitimacy and the main part name shows no legitimacy. Tags are then assigned as if the formerly conflicting part name is the main part name, and the previous main part name is now a conflicting part name.

Display codes may be generated for each part name during the algorithm. For example, once the specification is parsed and all part names extracted, each part name may be reviewed. A part may be given legitimacy if one or more it is the first occurrence in the specification, appears multiple times, and is preceded by “a”, “an”, “the” or other preceding words. A part may be given low legitimacy if one or more of it has no common words with the first occurrence, is not preceded by a preceding word, if it appears only elsewhere in association with another part identifier, and if it is associated with a suspect part identifier like a multiple of 5+10x where x is an integer (such are likely line numbers if the specification originated from an OCR process). In some cases, a subsequent occurrence of a variant or conflicting part name may be swapped as the main part name over the first occurrence, for example if the first occurrence has no legitimacy indicators and the subsequent occurrence has legitimacy indicators. Legitimate part names may be given display codes that make the part name always display in the list, and in a color intuitively associated with legitimacy (like black or white). Variants of part names may never appear in a normal mode of operation until the list is expanded, as such inherently legitimize the main part name as such have common words. Low legitimacy names may be given display codes that make the part appear in a color intuitively associated with low legitimacy (like red). Other style or properties may be used to communicate legitimacy level to the user.

In some cases the specification may have more than just parts wrapped by wrapper elements. For example, all figure references may be wrapped. As well, all non-validated alphanumerics may be wrapped. For example, all numbers 21 may be wrapped. Thus, even though the algorithm may decide that a particular occurrence of 21 is likely a value amount (21 degrees for example) and not a part identifier, the non-validated 21 may be wrapped, for example with a wrapper identifier that indicates that such is a red herring of 21, like red_herring_{—}21 for example). As well, all element names not associated with a part identifier may be wrapped. For example, element names may be identified by parsing the specification, ignoring part names, and identifying element names by looking at the remaining segments of text and ignoring stop words like has, have, comprising, and other non-element names. The remaining segments of text may be wrapped with wrapper elements, such as with wrapper identifiers prefixed with a suitable identifier prefix like non_part_element_x, where x is a number for example. All wrapper identifiers may be unique unless elements or other types of text may be grouped in sets, for example sets of same name elements, like the same phrase. The use of wrapping non parts may be in updating the list 34. For example, a user may cycle through the occurrences of a part, and want to see if the specification has more information on that part. Then, the user may click on a link to see all red herring hits for that part identifier. One may be determined by the user to be a legitimate part hit that was missed by the algorithm. The user may then send an update request to add that red herring hit to the set of occurrences for that part name. The wrapper identifier for that red herring hit may then be updated to the identifier common with that group. The updated list may be stored on the server for later serving. Similarly, a user may be presented with the option of finding other occurrences in the specification that may be associated with a particular part. So, the system may cycle through element names that are the same or have words in common with the part name of that part. As occurrences of element names are cycled, an option may be given to the user to add the occurrence to the occurrences of the part. Again, the updated list may be stored on the server or the information updated as discussed elsewhere in this document.

Element names, for example including part names and names not associated or used with part identifiers, may be identified by parsing the specification, ignoring stop words like has, have, comprising, and identifying element names by looking at the remaining segments of text. The element names may include phrases, or may be broken into words. Part names found in a part list algorithm may be used to narrow down the element names, for example “resulting magnetoresistive head element” may be narrowed to “magnetoresistive head element” after reviewing the part list.

Part lists can be used for visual clustering. For example, patents may be clustered based on topics and parts related to each topic. Clustering is a method of categorizing and drilling down search results by analyzing the patents returned in a search. Thus, the topics and parts related to each topic for each patent may be indexed beforehand. Clustering may be further done by classification, such as USPC or IPC or CPC. Topics may be deduced by analyzing for particular high level characteristics of terms in a patent—for example terms appearing in one or more of the title, abstract, classification information, and high frequency terms in a patent may be classified as topics. In one case the highest frequency term is a topic, for example cross bow in U.S. Pat. No. 4,699,117. A term in the abstract may be classified as a topic for example if it appears in the title or is a high frequency term in the specification, for example one of the top three terms, or both. Terms include phrases of plural words. Each term may have associated a variety of variants of the term, for example Z if the term is XYZ, X, Y, and Z being words, and Z is used independently in the specification.

The parts of the patent may then be associated with each topic, for example those parts that have a TF of above a threshold, and for who also have a TF IDF score above a threshold indicating that the parts are not merely common names of little search value. Common topics are found among the group of patents, and the parts associated with each topic may be listed together, with highest scoring parts appearing first in some cases, scoring being done by a TF-IDF method, highest frequency, or other analytical method. Parts, like topics, may be determined to be common by matching of at least one variant or by matching the entire part name themselves. Variants may be determined for a particular part in a patent based on the different uses associated with a part identifier, like “bow” or “cross bow” both associated with part 10 for example. Variants may be expanded by analyzing multiple patents that share such parts, for example if patent A has “cross bow” and “bow”, and patent B has “cross bow” and “crossbow”, then all three variants may be associated for that part, and other patents with one or more of the variants will be considered to have the part in common.

Non-part element names may be included in the cluster list, for example if such element names pass certain threshold criteria like minimum TF-IDF score or minimum frequency. Non-part element names may be distinguished from parts in some manner, for example by flagging one or the other, so that the user can readily distinguish between patents in the clustered list that show the element as a part in the drawings and patents that merely mention but do not use the element as a part. The resulting cluster list may have two or more levels: A first level of topics, with each topic being expandable to show a second level of associated parts. The most relevant part name variant may appear for each part, for example “cross bow” may be more common or relevant than “bow” or “crossbow”. A further level may appear above the first level, for example a classification level, such as a USPC or IPC or CPC class level. Thus, a user may click on a class to expand the topic list for that class, and then click on a topic in the list to expand the part list for that topic. Thus, a multi-tiered clustering module is provided for a user to navigate search results and find particular components of interest. The number of relevant patents satisfying a topic, class or part may appear adjacent the name of the topic, class or part to assist the user in gauging popularity of the same. Clicking on a particular topic, class, or part may bring up the relevant patents satisfying the criteria.

Each classification, for example a USPC or domestic classification, may have associated with it the element names and/or parts of patent references listed under that classification. Association with a classification may be done if an element or part meets a certain threshold, for example a particular TF-IDF score, and the patent is listed under that particular classification. Thus, a user can enter a query and the query can be run against the index to determine relevant classifications to search in. As well, synonyms may be generated for the keywords in the query, for example using a thesaurus, and once a classification is found, for each keyword synonyms may be dropped if they are not associated with the particular classification, for example the most relevant or two or three most relevant classifications or a selected classification. Synonyms appearing in the classification may be retained. Each classification may be restricted to a particular number of associated terms to reduce static in the method, for example one hundred terms per classification, or terms achieving a minimum TF-IDF score, or a minimum TF score such as 5%. The query, along with synonyms, may then be run against the patent database or patents in the classification, and results returned.

The query may be broken up as follows. If XYZ is the original query, X, Y, and Z being words, and JG are validated synonyms of Y, while DF are validated synonyms of X, the query may run in Boolean form as (X or D or F) AND (Y or J or G) and Z. In other cases the query may match patent references in which P % or more of the terms in the query are matched. The query may also have a minimum document frequency, for example 5, so that if five or less documents are found for a particular term in the query, that term is ignored. By converse, a maximum document frequency may also be defined, so that if more than L % of documents have a particular term, that term is ignored as being too common A minimum and maximum term length may be defined, so that terms with lengths outside the range are ignored, for example “be” may be ignored if the cutoff is words of three or more characters.

Referring to FIGS. 21 and 22, a particular display mode is shown. In FIG. 21, a patent is displayed, for example as a result of a selection from a results list. The drawings 38 are shown on the right, and a part list column 34 to the left of the same height as the drawings 38. An expand/contract button 150 may be clicked to display the specification 40, or the specification 40 may appear as soon as a user clicks on a part, such as flying head slider 19 as shown, in the list 34, see FIG. 22. The specification may appear as an intermediate column in between the drawings 38 and list 34, since the focus has shifted from the part list—drawings to the specification—drawings. The button 150 may be clicked to return to the view shown in FIG. 21.

Other types of searches are disclosed.

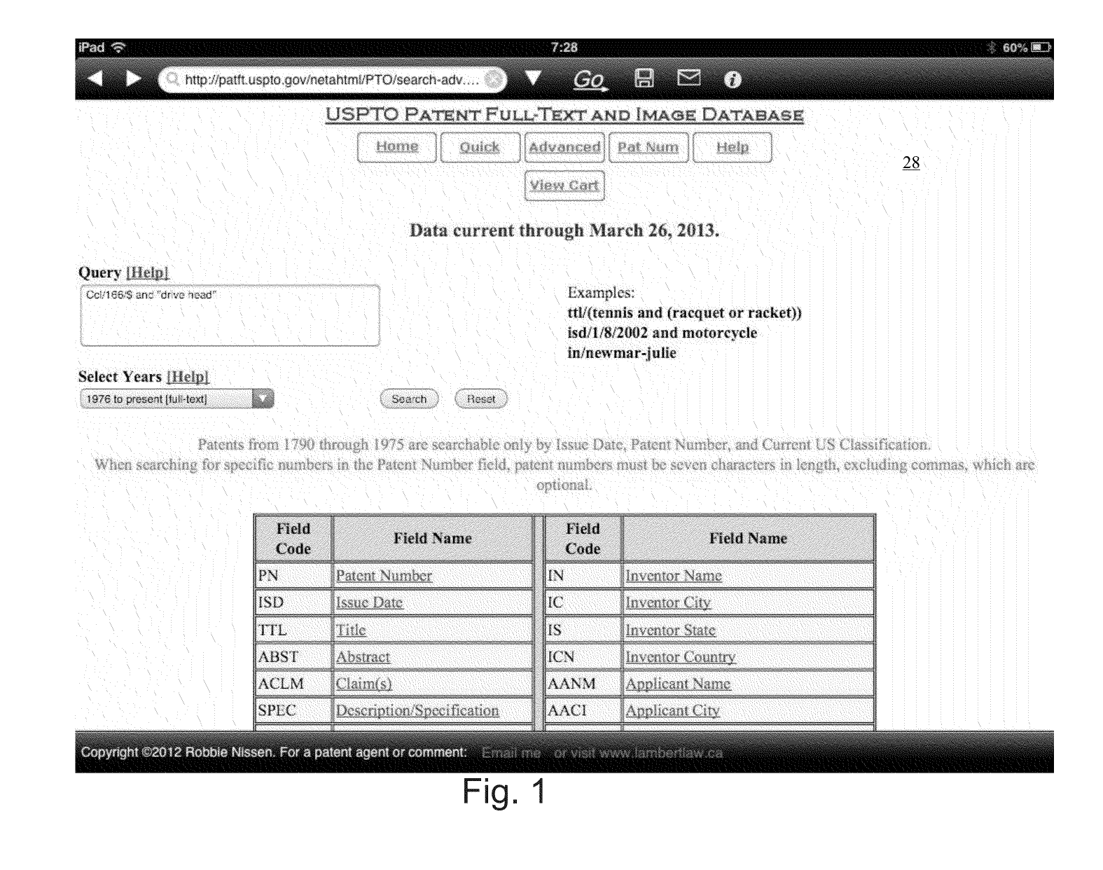

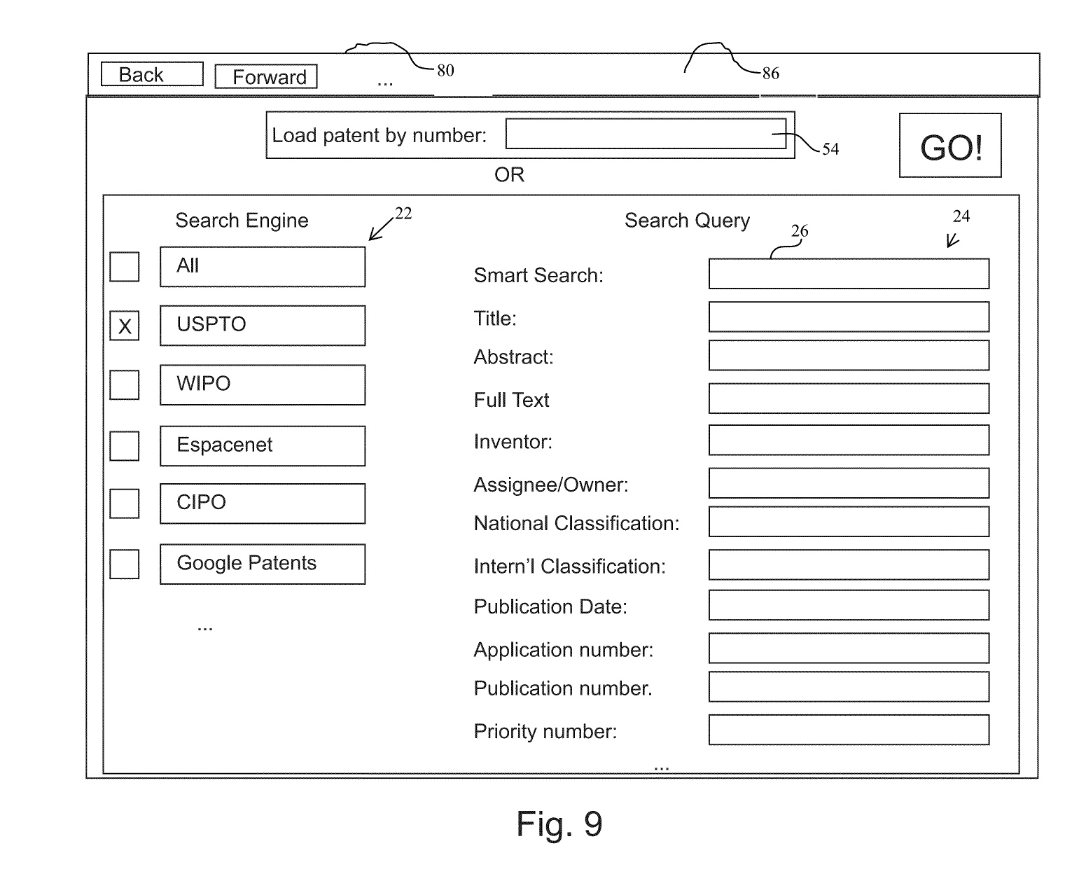

Referring to FIG. 1 a user may normally begin a patent search by navigating to the website 17 from equipment 16. Referring to FIG. 9, the website 17 may display a web page as shown, offering the user a selection of one or more search engines to use in area 22 of the screen. To navigate to the page of FIG. 9, the user may have had to first log in by entering a username and password.

Depending on what search engine is selected, a normalized search query form 24 may be displayed in the screen. If more than one or all of the search engines are selected, the form 24 may update to include only queries that are common among the search engines. A single “smart search” bar 26 may be positioned in form 24 in order to allow a user to enter a search query or queries in a single line. This bar 26 may echo the selected search engine's smart search option, for example if the selected search engine is the USPTO, then the bar 26 may follow all the advanced search query and boolean rules that the USPTO follows, for ex. using “abst/peanut” to search for peanut in the abstract.

Referring to FIG. 1, although a normalized form 24 may or may not be used to enter search queries, in some modes the selection of a search engine will navigate the user to the search engine's search query page 28. The user may then enter a search query as shown, hit search, and the search engine may then navigate to a search results output page 30 as shown in FIG. 2. The page 30 may be displayed on the user's screen as shown, and displays a search results list 32 of one or more patent references. The user is then free to select one of the patent references. Often a search engine 12 will associate a hyperlink with each reference.

Referring to FIGS. 2 and 3, the user may then perform a user selection event associated with loading a patent reference from the search results list 32 by clicking on a particular patent reference, in this case U.S. Pat. No. 7,980,316. The user selection event is identified by the system 10, either at the user equipment level or at the processor 18 level, and a function is performed by or as directed by the one or more processors 18, which are independent of the patent search engine 12. In other words, the capability offered by the search engine may be upgraded by capturing the user's intention to proceed to view a single patent from a search list, and redirecting or supplementing the search experience in a number of different ways. The function implemented may not be offered by the search engine, for example automatic reference element list 34 generation is not currently offered by any search engine 12 to the author's knowledge. The only connection between the one or more processors 18 and a patent search engine 12 may be the ability to access the engine 12 through the internet, because the engine 12 is effectively a third party legally and materially unaffiliated with the processors 18. Identification of the user selection event may include intercepting the event when an output page 30 is shown, in order to redirect or supplement the browser's pre-set method of dealing with the user selection event.

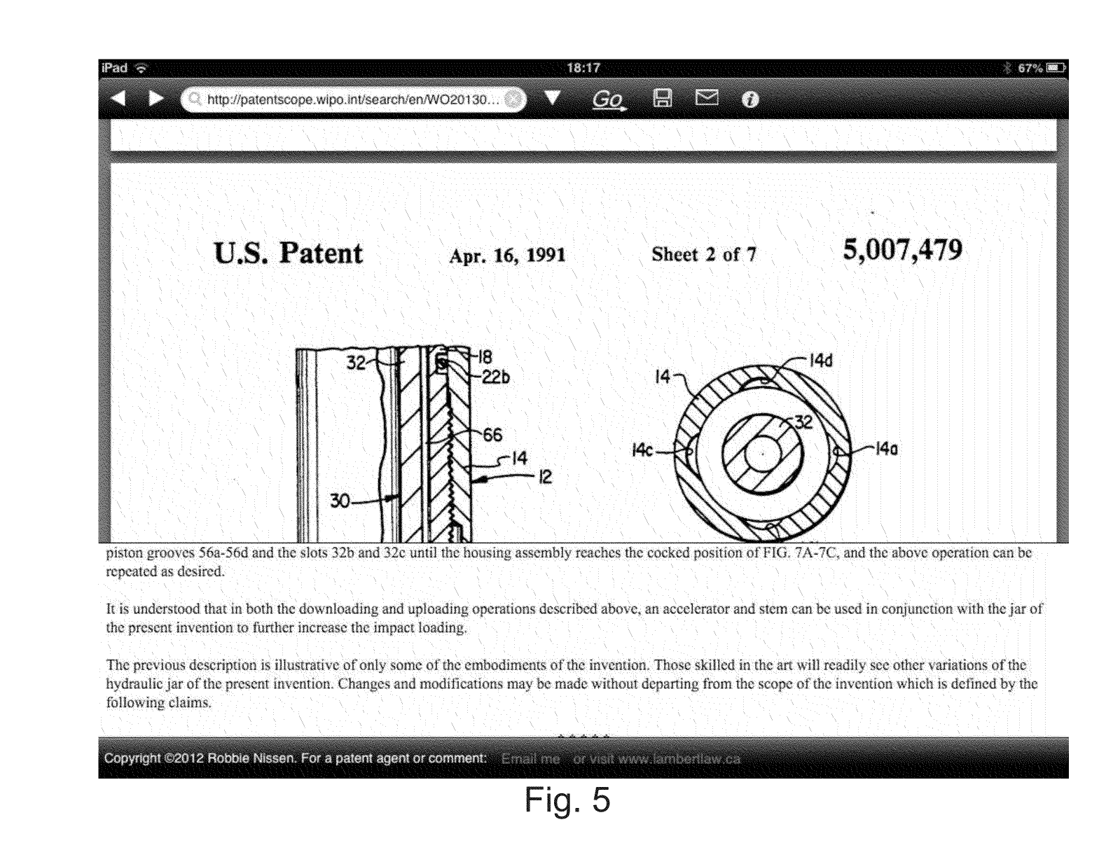

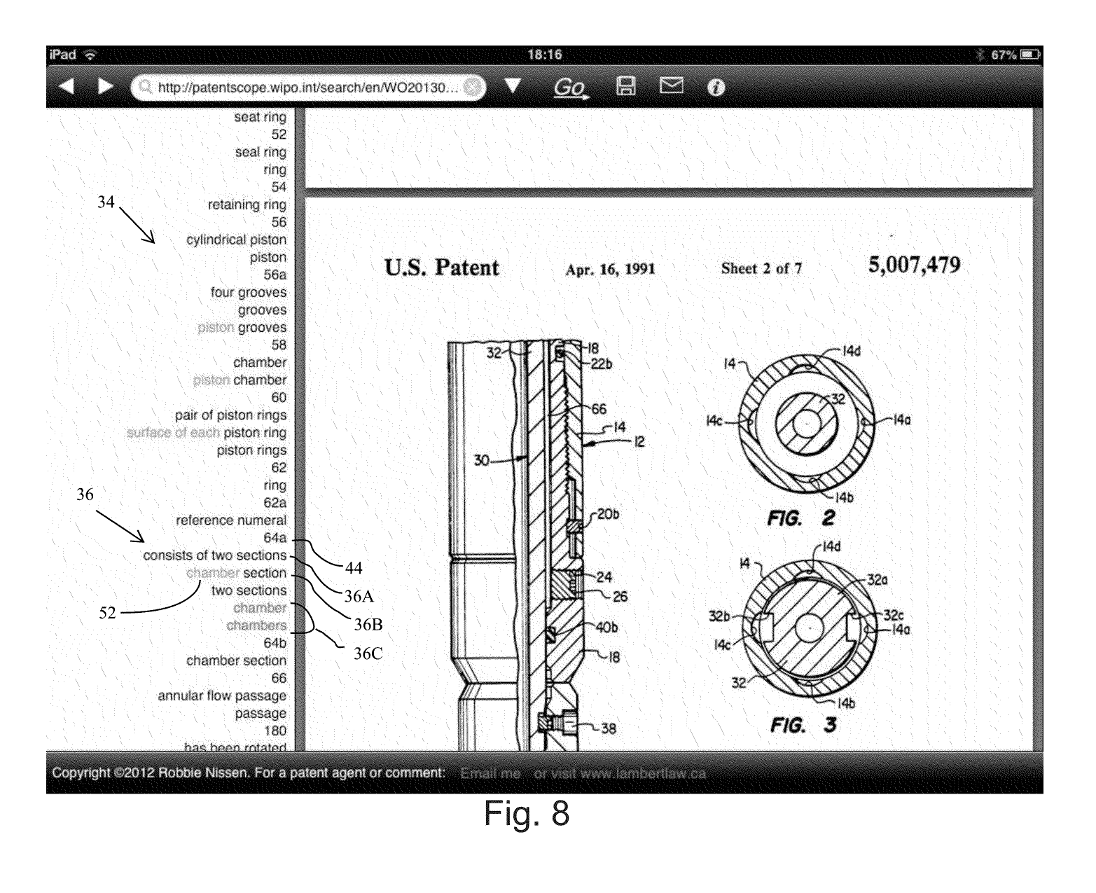

Referring to FIG. 3, in the example shown the function comprises a display function. In the example shown the function comprises displaying on one or more screens 16 of user equipment, both a list 34 of the reference elements 36 and at least some of the one or more drawings 38, and in some cases the specification 40 as well, of the patent reference selected in the user selection event. The use of list 34 in conjunction with one or both the drawings 38 and specification 40 is useful to permit efficient review and understanding of the patent selected. In the example shown the drawings 38, list 34, and specification 40 are shown in a split screen mode that provides a larger relative viewing area for the drawings 38. FIGS. 5 and 8 show alternative split screen modes, which may be used to emphasize different features such as the specification 40 (FIG. 5) or the list 34 (FIG. 8). Split screen modes may be cycled or navigated by a user command or shortcut such as double left or right-clicking on one of the webivews, panes or views 37 that contain 34, 38, or 40. Another command like double left or right clicking may be used to cycle a webview clicked on between full screen mode and splitscreen mode. Each view 37 may be scrollable, for example as a scrollview, and may be zoomable.

The list 34 of reference elements 36 may be generated on the fly using the specification 40, or may be loaded from a pre-generated database 19 accessible by or provided as part of one or more processors 18. In some cases the part list 34 may be auto-generated and entered into database 19, or may be manually entered, or auto-generated and then manually updated and saved in database 19 as described below. Exemplary methods of generating the list 34 are discussed in US patent publication nos. 20120204104 and 20090276694, and U.S. Pat. No. 8,160,306. The lists 34 may be generated by parsing the specification. A preliminary step may include analyzing the specification, usually in the form of an html page, text data, list, array, or j son object, and cutting out or ignoring irrelevant parts of the html, such as search engine headers, html code, claims, references cited by/citing lists, html trees, and other parts.

The bibliographic information of the patent reference is first checked to see if any drawings are present. If no such information is available, the specification 40 may be reviewed for the presence of language indicating that figures are present, for example if “FIG” or “FIGS” is present then continue. For OCR'd US patents from 1920-176 the phrase “No Drawing” is checked for as this is a reliable indicator that drawings are not present. If drawings are present the algorithm proceeds. Different filters may be used depending on the content of the specification 40. For example, if DNA words are found, a DNA specific mode may be induced where by each part name during validation is reviewed for the presence of specific prohibited words like amino acid names, which commonly appear in such patents in association with numbers. Chemistry words and chemical structure language may be detected and a similar filter invoked.

In some cases the system 10 may extract only the display text of the specification, and may then remove all html code from the display text. A further preliminary step may be identifying if the specification refers to any drawings, and if not, then stopping the list generation process altogether. Most reference elements contain a part name 42 and a part identifier or number 44, which may be numerical (ex. 10), alphanumerical (ex. 10A), alphabetical (ex. A), or in rare cases non alphanumeric or a combination of alphanumeric and non-alphanumeric (ex. A′). A processor may be used to determine if the specification came from an OCR process. For example, the USPTO publishes OCR text data only for patents issued between 1920 and 1975, and thus a US patent from this era will be assumed to be an OCR patent. Other mechanisms may be used to determine if OCR was used, for example based on a percentage of words failing a spell check, or based on a frequency of line breaks indicating a break after each line of text in a pdf.

The specification 40 is then parsed using one or more validation modules to validate words in the specification as being part names or part identifiers. Validated words are used to generate a list of part identifiers with associated part names from the selected patent reference. If the specification is determined to have originated from an optical character recognition process, the validation module operates at a first level of restriction. If the specification is determined to have not originated from an optical character recognition process, the validation module operates at a second level of restriction, the first level being more restrictive than the second level.

If the feed specification 40 is from an OCR process then alphabetical characters may be ignored to reduce static in the list 34. If the specification 40 is from a non OCR process than single character alphabeticals may be validated. The list can be generated by first obtaining a copy of the specification 40 or by retrieving the specification 40 from an in house database. Next, the part numbers are identified in the specification 40, for example by checking each word in the specification 40 in its own context to ascertain if a word is a part number 44. A regular expressions command may be used for this purpose. Once identified, the algorithm may track backwards word by word from the part number to ascertain the part name. The algorithm may stop adding words to the part name 42 if a prohibited word is encountered like “a” or “the” or “Fig.”. The algorithm may check before and after the part number 44 for words that indicate that the part number 44 is an amount and not a part number, for example if the text reads “55%”, then 55 is not a part number. A list of all the occurrences of each part number 44 and associated part names 42 are generated, and the algorithm picks the best part name 42 to include with the respective part number 44 in the final list 34.

For most reference elements the best name is the first occurrence. However, it is common to make mistakes in patent drafting that may lead to confusion as to the proper part name to use. For example, a drafter may refer to a “hammer 10” as a “wrench 10” as well. In this case, the algorithm may leave the selection of the correct part name to the user or may perform conflict resolution to determine the appropriate part name. This can be done in several ways. Generally, the first occurrence is given priority. If the subsequent spelling “wrench 10” appears more times than the “hammer 10”, then “wrench 10” may be substituted as the primary part name, unless the first name shows some legitimacy such as by appearing more than once or being initiated by a part initiator like a or the. Other conflict resolution algorithms may be used. In comparing the first occurrence and the subsequent occurrence various for primacy various factors may be considered, such as number of occurrences of each, whether any of such occurrences are preceded by a part name initiator like “the” or “a”, whether or not the name appears more than once, whether or not the part identifier is likely to be a page or line number, for example if it is a multiple of 5, there are numerous unique names for the part num, and each name appears only once, whether or not the same name appears elsewhere in the list, and whether or not the name is the first occurrence. Conflicting part names, variants or even main names of low legitimacy may be flagged in list 34 for example in red to suggest to a user that the user may consider deleting the part name or confirming the validity of the part name. How stringent the conflict resolution process is may depend on whether or not the specification 40 was obtained by an OCR process or patent office validated text.

Other levels of validation may be used. For example words starting with an alphabetical character and having one or more numbers, for example “DR1” are not validated as part identifiers in the first level of restriction but are validated as part identifiers in the second level of restriction. Words starting with numbers and terminating in alphabeticals, such as 1D may be validated at both levels. Numbers of multiples of five may be given lower weight during validation in the first level than in the second level. For example, the numbers 5, 15, 25, and up, i.e. numbers of the form 5+10(x), where x is an integer, may be indicative of line numbers taken from the OCR process. Unless there are contextual factors pointing towards the validity of such numbers as part identifiers, such numbers may be excluded or flagged as likely misses. Contextual factors supporting validity include more than one occurrence of the part name associated with such line numbers, and the use of subsequent stop characters like a period after the number. Numbers of form 10(x) where x is an integer, may also be treated with such suspicion, for example 10, 20, 30. Words equivalent to two or three character country codes from a list of country codes are not validated in the second level but are validated in the first level. For example, use of the word “US” or “PCT” or “WO” followed by a number are likely references to patent references, and should be excluded when the source specification 40 is of high quality. However, with an OCR text such words could just as easily be part of actual words, for example “US e” (use), “PCT” (pot), or “t WO” (two).

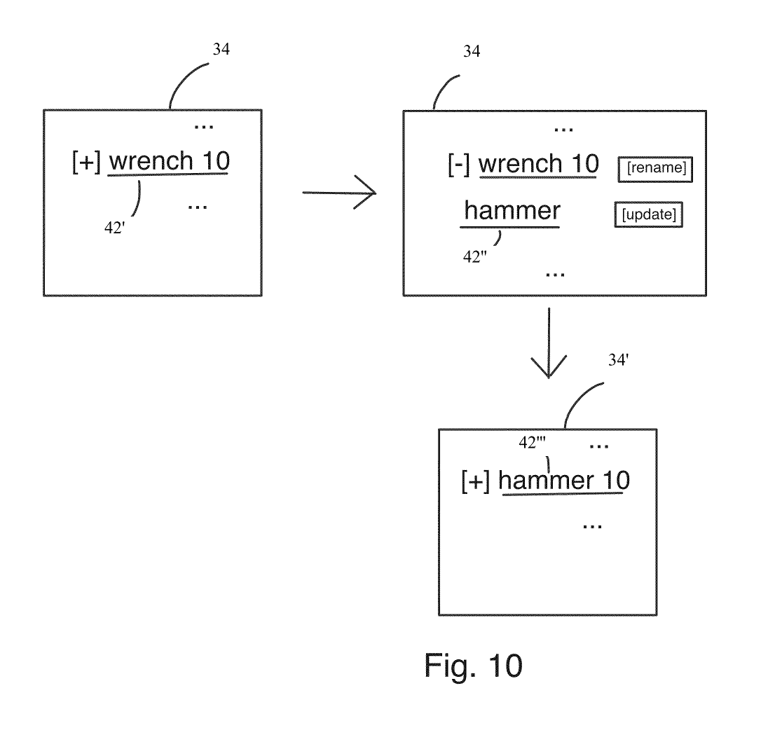

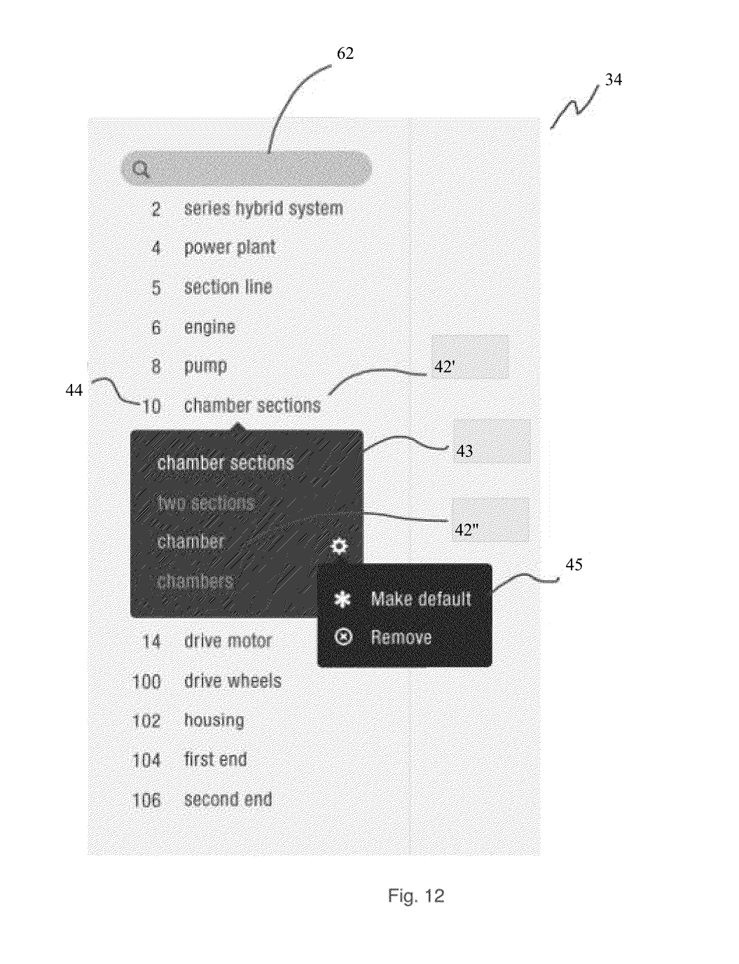

Referring to FIGS. 10 and 12, in some cases the system 10 may use crowd-sourcing to update a list 34. First, information may be retrieved from one or more servers 8 (FIG. 11). The information may include a specification 40 in some cases, and the information used, for example in a javascript or other browser based algorithm for parsing specification 40 and outputting a list 34, to display a form containing list 34. In other cases the information may include list 34, for example if the database 19 stores auto-generated lists 34 or if the list 34 is generated on demand by the server 18 when a patent is selected. In response to a user update list event, an updated list 34 may be transmitted to servers 18. In other cases transmission may be of update information, such as a command to delete part name X or part identifier Y, associated with the user update list event. Various user update list events may be used. Referring to FIG. 10, a user may click on the [+] sign if the user considers the initial part name 42′ to be inaccurate and wants to expand the list to see subsequent names for part number 42′. A sub-list appears below the initial part name 42′, revealing the other occurrences or subsequent part names 42″ used in the specification 40. If the subsequent names are variants of the main name, for example tong wrench, the user may opt to retain the subsequent name. However, in the example shown the name hammer is unique from the name wrench, and likely denotes an error. A user may manually update the list 34 by clicking “update” next to the desired subsequent part name 42″, or by clicking “rename” to manually rename the part name if none of the listed part names are appropriate. Subsequently, the list 34 is updated to incorporate the updated part name 42″ as the default name. The updated list 34′ of reference elements may then be transmitted to and stored in one or more databases 19 (FIG. 11) for later viewing. In some cases the specification 40 is stored as well, for example if the specification 40 has html wrapper tags inserted at or around part names or part identifiers for quick identification of the locations of selected reference elements. In some cases, the updated list 34′ may be displayed in conjunction with the one or more drawings 38 in other embodiments disclosed in this document. Other methods of permitting a user to manually update the list 34 may be used. Referring to FIG. 12, a menu 43 may appear when the system detects that a user wants to check the other occurrences of a part number 44, for example if the mouse icon hovers over the default part name 42′ for a predetermined period of time. Colors or other indicators may be used in menu 43 to indicate the default part name 42′ (white), and the selected subsequent part name 42″. A sub menu 45 may appear if the system 10 detects that the user may be interested in making a subsequent occurrence 42″ the default element name (yellow). Menus 43 and 45 may be pop-ups or available as a result of a user click event. If a user clicks on a subsequent occurrence 42″ the system 10 may perform a text search of the specification 40 for only those occurrences of the subsequent occurrence 42″.

The user may also be given the option of adding a new or deleting an existing reference element. Once deleted, the system 10 may add the deleted part name to a black list and re-run the list generation algorithm, filtering out the items on the black list. In some modes the algorithm may only clear relevant html wrapper tags from the specification. The black list may be stored in database 19. In other cases the list regeneration is never re-run once the list 34 has been manually updated by a user, since such updating gives the list some level of validation. The use of html wrapper tags may be replaced by using another system of retaining knowledge of the location of each part identifier or part name, for example using a hidden comment tag, or a list of character locations associated with the list 34. The addition of html wrapper tags may occur in the browser before being fully displayed.

When the updated list or list of updated information is stored by system 10, the user implemented modification may be flagged, for example for review by an administrator or for priority on subsequent generation. The latter case is explained as follows. The system 10 may preferentially load a saved list 34 over generating a new list for a user, to reduce processing time and resources. However, the algorithm for list generation may be updated from time to time, in which case the system may rerun the algorithm but take into account manual user changes to the list, as such changes are generally more accurate than those made with an algorithm. Thus, on conflict resolution between the old and new list, priority may be given to user implemented modifications of an earlier list, so that the system keeps the user implemented changes. If different users update the same list 34 in a conflicting or contradictory way, the system 10 may perform a further conflict resolution or may flag the list for review by an administrator to resolve. Screening of the list updates may be checked for compliance with a predetermined quality threshold. Offensive words may be filtered to avoid tampering with the list, although in general only paid subscribers may have access to system 10 thus reducing the chance of tampering. Words not found in the dictionary may not surpass the threshold or may cause the update to be flagged for human review before implementation.

Referring to FIG. 8, a list 34 of all the occurrences or unique occurrences of reference elements 36 is shown. Reference elements 36 may be right aligned with or without part numbers 44 in the right most position (not shown) for quick analysis. For example, rows in the list 34 may be displayed in the form of a combination of part identifier with a respective part name to the left of the part identifier, in which the respective part names are right aligned, the combination is right aligned, or the respective part names and combination are right aligned. In the example shown in FIG. 13B the part identifier is left aligned and the respective part name is right aligned. A single space, tab, or other separator may be between identifier and name. Figure names may be present in the list 34 or another list in such a fashion. Right alignment and positioning the identifier to the right of the name makes the part read more like it does in the specification, and de-emphasizes words, on the left end of the part name, that may not be part of the actual part name, such as “resulting” added to “magnetoresistive head element” 31.

Different methods, such as color coding, may be used to bring inconsistencies in part naming to the user's attention. For example, for part number “64a” in FIG. 8, green is used to indicate a word 52 in a subsequent occurrence 36b that diverges from the first occurrence 36a of the part name of “64a”. Green is used in this example to indicate partial divergence that occurs when one or more of the right most or primary words corresponds with the right most words of the first occurrence 36a, but one or more words to the left of the corresponding words is different. Red is used in this example to indicate situations where a subsequent occurrence or occurrences 36c completely diverge from the first occurrence 36a, as shown. Color coding and text comparison of this sort may be used during list generation to improve the list 34. Plurals may be filtered out to avoid false negatives, for example “sections” in 36a is considered equal with “section” in 36b.

As discussed elsewhere in this document, the parsing algorithm may filter out part identifiers and part names that should not be listed, and in building the final list the validated occurrences of the part names and/or part identifiers in the specification may be wrapped in html wrappers such as a span element. The wrapper element may be given any number of classes or IDs (wrapper identifiers) for later text searching for example in the browser. For example, all variants of the main name for a given part may have a general class name, such as part 54, as well as a class name specific to the particular variant, for example part_{—}54_{—}2 to indicate by the 2 that the variant is the second variant. When the list is arranged for text searching in the browser, a click on the main part name will search the general class, while a click on a variant will only search the specific class. Thus, in FIG. 8 clicking on “four grooves” 56a will scroll through all variants of part 56a, while clicking on “grooves” will scroll only the “grooves” variant. Totally unique names, also referred to elsewhere in this document as conflicting names, for example names that are entirely unique from the main part name, such as chamber in the case of part identifier 64a in FIG. 8, may have a class that does not overlap with the main part class system, for example part 64a_{—}0_{—}2 with the 2 indicating that this is the second unique part name. Classes and IDs are used commonly with HTML but other appropriate techniques may be used by other display methods.

The use of html or other wrapper markup elements (also called wrappers) may require updating specification 40 with updates to the list 34. For example, when a new part name and part identifier is added to the list, a process may be run that cycles through hits of the appropriate part identifier and a decision made by the user to accept or reject the selected term as an occurrence of the part identifier. In other cases, to simplify updating once a part is added all occurrences of terms equivalent to the new part identifier may be added. As well, if a variant or conflicting name is deleted, a decision may be requested to be made by the user as to whether or not the occurrences of the conflicting name or variant should be unwrapped or if the occurrences should be retained under the general class so that such variants appear when a user clicks on the main part name.

Various other updates may be used. If a unique part name exists after the main part name, such as wrench 12 when the main part name is hammer 12, the user may renumber wrench 12 as wrench 14. In doing so the class name for the wrench 12 occurrences may be replaced with the general class used by wrench 14 occurrences, so that the wrench 12 occurrences in the specification 40 show up when a user clicks on wrench 14. As well, a user may decide that a subsequent unique occurrence should be treated as equivalent to a variant of the main part name. For example, the main name may be junk, and the unique part name may be trash, and in that case trash should be treated in the same fashion as a variant of junk and not an erroneously added unique name. Thus, clicks on the name junk should cycle through trash as well. In such cases the two unique names may be combined, to give “junk or trash”. In other cases the wrapper class of trash may also be updated to include the general class of junk, so that clicking on junk will cycle through occurrences of trash as well. In other cases the main part name and a subsequent unique part name may be swapped. Variants may have at least one common word, in some cases the right most word. Thus, in some cases a variant of term XYZ (where each capital alphabetical character is a term) may include YZ and Z. In some cases Y or X or XY are variants, while in other cases such are not. RYZ may also be a variant.

Thus, updating the list 34 may include updating the specification 40 as well. For further example, a user may decide to add an occurrence of a term flagged as a red herring to the list 34 under the same part identifier. Thus, as a user is cycling through the red herring occurrences, a decision may be made by a pop-up or provision of an acceptance button or other suitable method to permit the user an opportunity to approve including the red herring as an occurrence that should appear in the part list. In such a case the red herring may have a wrapper and the wrapper may have added the general class of the main part name to allow clicking on the main part name to scroll through the previously labelled red herring term. Thus, the updated list 34 and updated specification 40 are stored in database 19 in some cases upon updating.

The specification 40 may be obtained through an optical character recognition (OCR) process of an image version of the specification 40. In many cases the actual text of a patent is only available in image form, so the images must be translated into text before the list 34 can be generated. This is particularly true of US patents from before 1976.

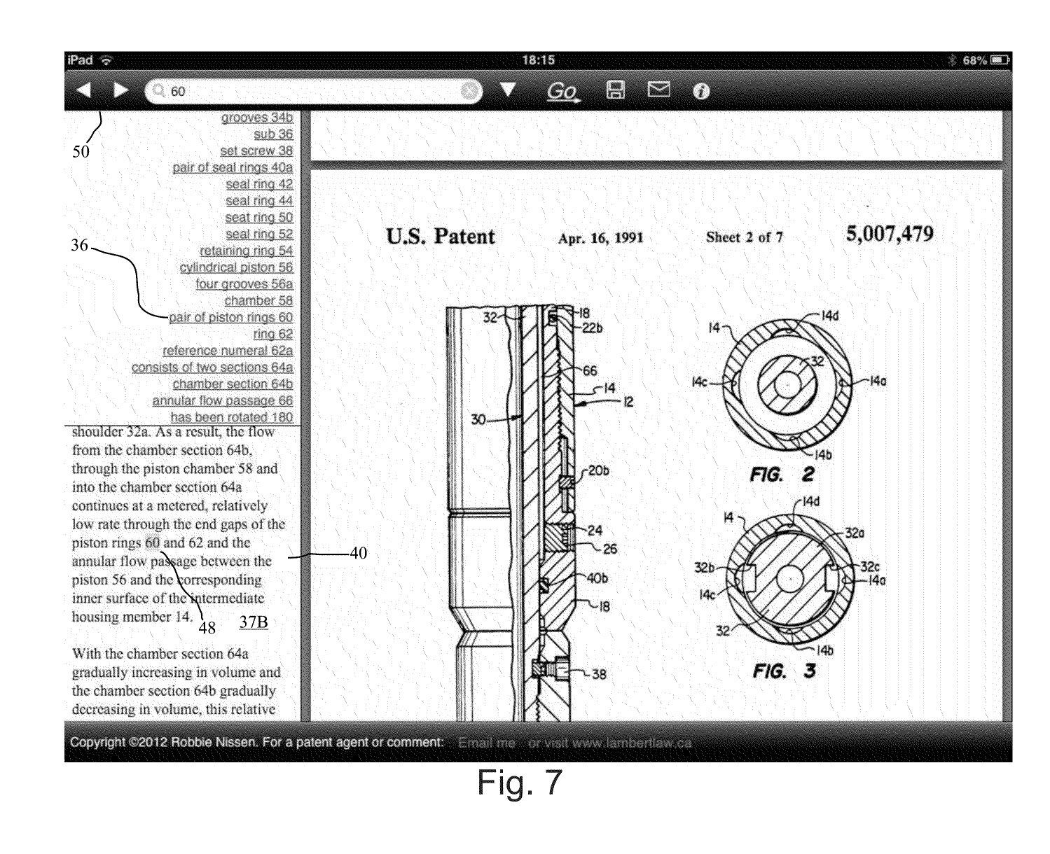

Referring to FIG. 3, as discussed above the list 34, drawings 38 (for example in the form of a .pdf of the patent as shown), and the specification 40 may be displayed in conjunction with one another. An extended info option (not shown) may appear for user selection somewhere on the page to allow a user to navigate to a url or page that has more information on the patent, for example the home url of the reference on Google Patents or another patent search engine. Text searching options may be available to permit the user to search the specification 40 for a part number 44 or other word or string of words as is desired to assist in understanding the patent. One such way of text searching is using a text searchbar 46 as shown. Another way is to link each reference element 36 in the list 34 of reference elements to highlight a reference element identifier such as the corresponding part number 44 as shown or the reference element itself in the specification 40 on a selection find event of the reference element in the list of reference elements. Referring to FIG. 7, a selection find event may be carried out by the user by clicking on the hyperlinked reference element of “pair of piston rings 60”. The system 10 identifies the event, and highlights the reference element identifier, in this case the corresponding part number 44 of “60”, by changing the background color around the occurrence 48 of “60” in the specification 40, and scrolling the webview 37B containing the specification 40 to the appropriate occurrence of “60” as shown. Subsequent clicks on the reference element 36 in list 34 may advance to the next occurrence of “60”, and so on.

The text search may be improved when carried out from list 34 to filter out non reference element occurrences. For example, only exact matches of the part number 44 may be highlighted in the specification on the selection find event. In other cases, during the list generation stage the locations of each reference element occurrence are tagged, for example by inserting a unique javascript or other span class around the occurrence in a form invisible to the user, in specification 40. Non reference element occurrences are not tagged, so that subsequent searching for a reference element is focused and irrelevant occurrences are removed. Thus, if a user clicks on “widget 19”, only occurrences of part name and number “19” that are recognized as reference elements will be highlighted, and non-occurrences like “1990” or “at a temperature of 19 degrees” are ignored. Such a focused search is more efficient when a user wants to quickly identify a passage of text relevant to the selected reference element 36, while not wanting to waste time scrolling through irrelevant occurrences. Back and forward buttons 50 may be used to advance or retreat to next or previous occurrences in the text search. Referring to FIG. 12, text searching of the list 34 itself may be done, for example using a searchbar 62 that filters list 34 with each character added to bar 62 so a user can quickly locate a particular part number 44.

Referring to FIG. 11, the one or more drawings 38 and specification 40 may be obtained from one or more online patent databases 14. For example, when a user selects a patent to load or manually enters a patent number in a load patent number bar 54 (FIG. 9), the system 10 may initiate download requests of the relevant databases 14. In many cases urls may be generated using only a url base and the identification information in the patent country code and number. This is especially true if the data is obtained from an API, discussed below. For example, pdfs of US patents may be obtained directly from Google in this fashion, for example http://www.google.ca/patents/US8160306.pdf. In other cases direct url generation is not possible or is not used. Thus, for at least one of the specification 40 or drawings 38 a first url may need to be generated from a first url base, the patent country code and patent number. For example, a url for a search request for MX2008011168 on espacenet may be first generated, ex. http://worldwide.espacenet.com/searchResults?compatc=false&ST=single&query=MX2008011168&locale=en_EP&DB=worldwide.espacenet.com. Next, further identification information, for example the publication date 20090210, is obtained from the data obtained from the first url, the data in this case being the html code of the search request page for MX2008011168. The publication date, country code, and number may then be used with a further url base to directly generate target urls for the drawings 38 from espacenet, for example: http://worldwide.espacenet.com/publicationDetails/mosaics?CC=MX&NR=2008011168A&KC=A&FT=D&ND=3&date=20090210&DB=worldwide.espacenet.com&locale=en_EP. The system 10 may insert different patent identification information into the same url bases to generate urls for different patents, since most sites like espacenet use a consistent url generation system to locate patent documents. The sequence of iterations may be repeated or added or subtracted to in order to provide the user with seamless access to the relevant documents upon the user selection event. In some cases, the specification 40 and drawings 38 may be obtained from different databases 14 and 14′, depending on what database is more appropriate. Thus, it may be more efficient to obtain the drawings of a PCT application from espacenet in mosaics form, but the specification for new applications should be downloaded from WIPO given the lag between publication on WIPO and subsequent publication of the specification on espacenet. URL generation may be used in conjunction with obtaining data from an application programming interface (API) such as Open Patent Services (OPS)

User initiated events may be identified in various ways. In an ipad app a user initiated event like a hyperlink click may be captured using the webviewshouldstartloadwithrequest function. Events may be identified at the user equipment 16 level or the processor 18 level.

Referring to FIG. 2 the search results list 32 is displayed as a separate list from the USPTO. In other cases a combined list or separate lists 32 may be displayed, for example in a web browser (FIG. 1), of plural search results lists from respective plural patent search engines 12. Referring to FIG. 9, a combined list (not shown) may be produced as a result of a search query submitted for more than one selected search engines 12. Redundant patent references appearing in more than one returned search results list may be removed for convenience. When the user navigates from FIG. 9 to execute a search, the system 10 may submit the search query to the patent search engine 12, and return the results either in the native format of an output page from the search engine (FIG. 2), or the system 10 may receive the results and list the results in a format determined by the system 10, for example if a combined list is shown with search results lists from plural search engines. The format determined by the system 10 may be normalized across all search engines to provide a consistent experience across search engines.

The methods and systems disclosed in this document may be carried out at least in part by a plug-in or software for a web browser, a mobile device app, or software for a multi-purpose computer running a suitable operating system. The website 17 may also provide a portal to the search engine 12 or engines 12 as shown in FIG. 1. Search engine 12 may include a national, regional, or international patent office search engine such as the USPTO, WIPO, the EPO, or espacenet. Engine 12 may also be a proprietary search engine like Google Patents, PatentLens, or SumoBrain.

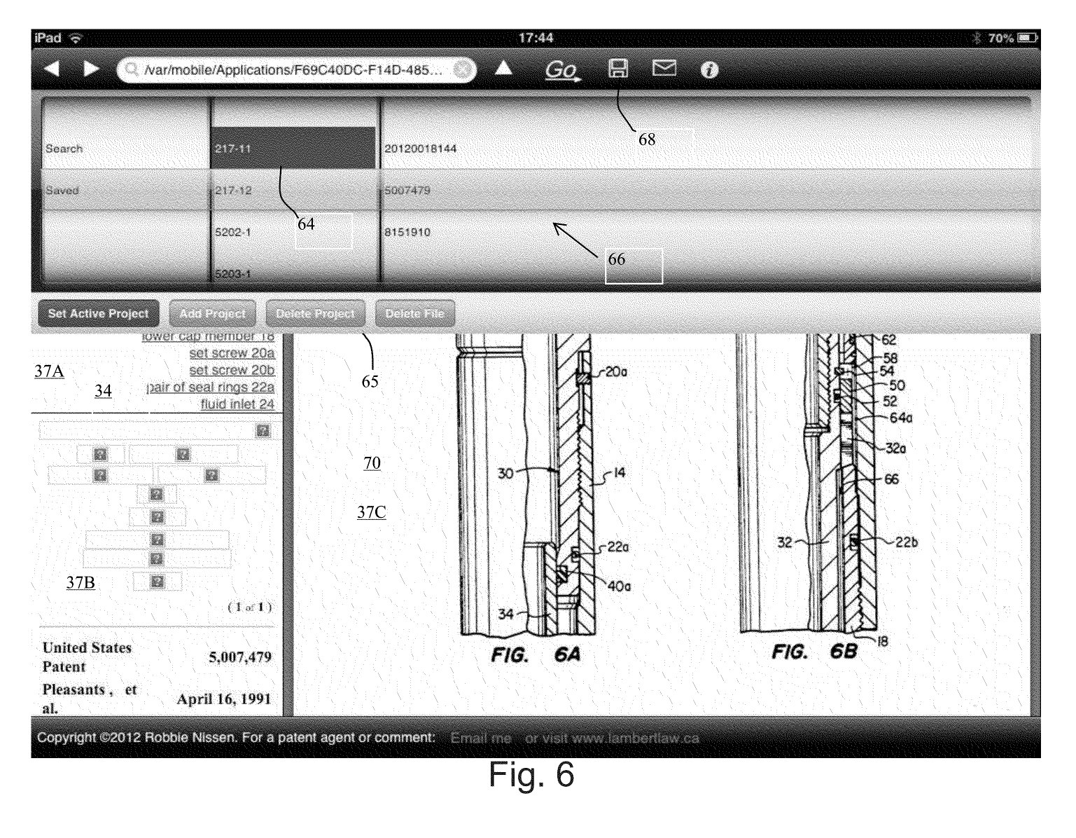

Referring to FIG. 6, the system 10 may allow the user to perform searches under a project name 64. Thus, in the example shown a drop down menu 65 is accessible for setting the active project 64 or adding/deleting a project as is desired. In the menu 65 each project 64 has an associated saved file column 66 that stores patent references that were saved at the user's option, for example by clicking a save 68 button. The user may select to save just the pdf 70 or mainview of a patent reference, or two or all of the webviews 37, including the list 34 if desired. In general a split screen view may be saved in a single document, for example a pdf, for off line viewing.

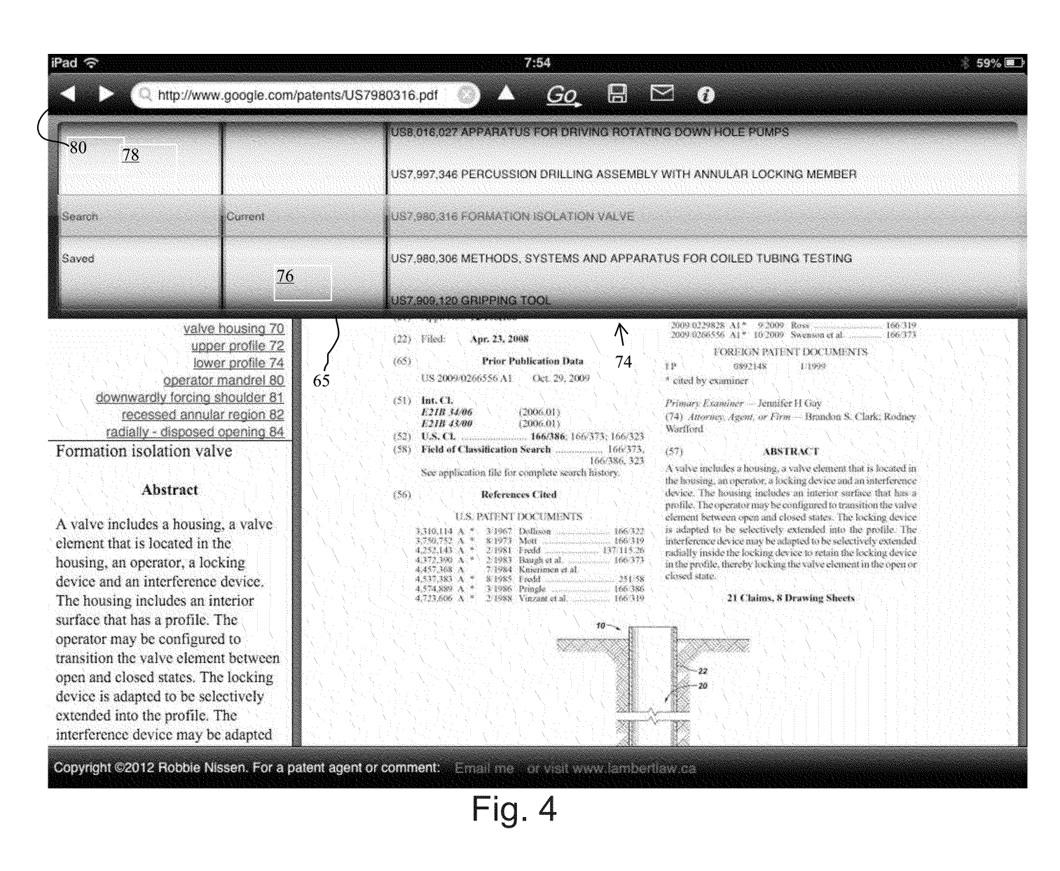

Referring to FIG. 2, if more than two patents are listed in the search results list 32 as shown, and the user selects one of the patents displayed in list 32, the system 10 may obtain identification information for each of the two or more patent references. A preliminary step may be carried out at this point to determine if the search results list 32 has already been stored, and if so the list storage process may be terminated. Referring to FIG. 4, system 10 may then store a list 74 of the identification information for later selection of the two or more patent references by the user. In the example shown the list 74 can be viewed by opening the drop down menu 65 and selecting the applicable search results list 32 from the search column 76, which may store other search results lists performed in this search. A further column 78 allows a user to navigate between mode a) where search result lists are accessible in the menu 65 (FIG. 4), and mode b) where saved patents are available in the menu 65 (FIG. 6). Thus, from the display page shown in FIG. 4 the user can easily and efficiently navigate through patents listed in the results list 32 without having go back manually to the search results page using the back/forward browser buttons 80, although buttons 80 may also be used for this purpose. The patent reference identification information from list 32 may be obtained in various ways. In one example, the system first recognizes a user selection event like a hyperlink click. It checks the page url to decide if the page is a search results output page, given the presence of certain url elements like in the case of the USPTO, the presence of “netacgi” and “patft.uspto.gov” or “appft.uspto.gov”. If yes, then the system scans the output page for hyperlinks, and checks if the hyperlinks are valid patent numbers. If a valid patent number is found, in the case of the USPTO the next hyperlink is usually the title of the patent number, and the title is stored as identification information as well. At each recognition of a new patent reference, the system checks if the user selected this subsequent patent, for example by seeing if the selected patent number is the same as the subsequent patent or if the selected hyperlink is the same as the hyperlink under review. If same, then the system gets the green light to continue storing the list 32, because a patent reference was indeed selected from the list 34. If none of the patent results were clicked, for example the user merely clicked on the “refine search” button and not a patent reference, the list 32 is discarded and no patent is loaded.

Referring to FIG. 4, each time a new patent reference is selected by the user, the system 10 may store identification information, for example the patent number and country code, of the selected patent reference, in this case U.S. Pat. No. 7,980,316. The identification information may be stored in a list of already viewed patent references. When the user reviews list 32 in drop down menu 65, patent references that appear and are listed in the already viewed list are flagged, for example by a different text color as shown, so the user can quickly identify that he or she has looked at this patent already. Traditional browsers store a list of urls clicked from hyperlink click events, and in subsequent pages that give the option of loading the same url, the browser will flag that this url has already been visited. However, if a user uses a different search engine 12, the browser will not be able to recognize that the same patent the user is now clicking on has already been visited because the hyperlinks used by each engine 12 are different. In the case of system 10, however, the system stores patent reference identification information and not the hyperlink url, and thus is able to recognize already viewed patents across plural search engines. Thus, when a subsequent search is carried out on a different search engine, the system 10 may flag in the subsequent search results list 32 that the same patent was already viewed in a different search engine. Thus, redundancy is reduced in the patent search process. Reducing redundancy is helpful particularly in the latter end of a patentability search where a user is very close to the target area and may more frequently come across patent references that were already viewed.

The system 10 may go further than the already viewed list, and may flag patent references from the same patent family as patent references in the already viewed list. Thus, continuations, divisionals, and child or parent applications may also be flagged, for example in a different color than used for flagging already viewed references, as patent family references are often similar or identical to one another. One rough way of determining if a patent is in the same family is by checking if the titles match, although this method is not foolproof A more accurate but processor intensive method would be to obtain bibliographic and patent family information from a patent database listing the patent of interest.

A unique already viewed list may be stored for each project, so that the already viewed list of one project doesn't interfere with the already viewed list of another project.

Back and forward buttons 50 and 80 may be the same buttons, and may operate with a module for recognizing what type of back forward event is desired by looking at the context before acting. Thus, if the user has entered a text to search in the searchbar, the buttons may act as buttons 50 and carry out a text search. If the searchbar merely displays the url of the main webpage 70, or displays nothing, then the buttons may act as buttons 80 and provide a back forward browser function, allowing the user to navigate through a stored history list of pages visited in system 10 or outside system 10. Searchbar 46 may also function as a web address bar for manual entry of a url to navigate to, by pressing for example the GO button to load the url instead of a textsearch button (not shown) that would otherwise execute a text search of the specification 40. An email button 82 may be provided (FIG. 3) for emailing saved references or notes. An information button 84 may be provided for providing helpful tips and instructions. A further button (not shown) may be provided to navigate to the home page shown in FIG. 9. One or more buttons or searchbars disclosed in this document may be located on a header 86 (FIG. 9) that appears throughout use of the system 10, for example whether viewing the home page (FIG. 9) or navigating to search results (FIG. 2). In other cases page change events are logged with the server but the browser back and forward buttons used to traverse history.

Referring to FIG. 9, individual references may be navigated to using bar 54. In addition, plural references may be navigated to, for example by entering a string of more than one patent reference followed by a space or other separator. On clicking GO, the system 10 may display all of the patents in tabbed or other views for easy navigation between references. A “download” or “save” button may also be present in FIG. 9 or in other views, in order to allow the user to save the patent to a hard drive in equipment 16 or to a user folder located on database 19 accessible only by a specific user account. User accounts may share information, for example if plural users want to work collectively on a search but want to avoid redundancy.

Search query history may be stored in a format that may be accessible so that a superior or a searcher can review the searches done for a project. An option may be provided to bring up a list of one or more of the references cited by and citing the selected patent reference. References cited by and citing may be derived from online public sources, such as the USPTO and espacenet who both list such citations.

An option may be provided for a user to have the system 10 use the list generation algorithm to analyze the text of a drafted patent application for review purposes. The screenshot in FIG. 8 illustrates how the list algorithm may be used to identify drafting mistakes, so such mistakes can be fixed. A button or option may be used in this context to fully expand or display a fully expanded list to show all occurrences of each reference element, or at least all unique occurrences.

A normalized display of the specification 40 may be used, for example containing only the specification, namely the abstract, description, and claims, without the drawings, search engine headers/footers, or bibliographic information. The normalized display may include images like chemical formulae or tables that are present in the specification. The normalized display may be created by combining the description and claims scraped from different respective urls, for example in the case of international applications scraped from WIPO or EP applications scraped from espacenet.

The embodiments disclosed in this document may be used with a search engine that is not independent of the one or more processors 18 in some cases. Other names for list 34 include an index or bill of materials.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method for searching a group of patent references, one or more of the patent references having associated a) one or more drawings, and b) a specification, in which a) and b) contain corresponding part identifiers, which are each associated with a part name in the specification, the method comprising:
displaying on one or more screens a form with one or more text entry query fields;
in response to a user query event, performing with a processor a query, using text in at least one of the text entry query fields, of lists of part names, the lists being stored on a computer readable medium, each list being associated with a respective patent reference of the group; and
displaying on the one or more screens a results list of one or more patent references found in the query.

2. The method of claim 1 in which the text entry query field is one of a plurality of query fields each associated with querying a respective set of information associated with the patent references.

3. The method of claim 2 in which the plurality of query fields include a first query field containing one or more user-entered search terms, and a second query field containing one or more user-entered search terms, in which the query is performed by querying:
lists of part names using the one or more user-entered search terms in the first query field; and
a set of information associated with the patent references using the one or more user-entered search terms in the second query field, the set of information associated with one or more of the abstracts, titles, specifications, detailed descriptions, claims, inventor names, applicant names, and classifications, of the patent references in the group.

4. The method of claim 3 in which the set of information, which is queried using the one or more user-entered search terms in the second query field, is associated with the specification or detailed description.

5. The method of claim 1 in which the query of the lists of part names is performed using text in the text entry field, of an index of a combination of lists of part names and one or more of titles and abstracts, the one or more of titles and abstracts being stored on a computer readable medium, each of the one or more of title and abstract being associated with a respective patent reference of the group.

6. The method of claim 1 in which the query of lists of part names is carried out on an index exclusively containing lists of part names.

7. The method of claim 1 in which the one or more screens are located at a first location associated with a user, and the computer readable medium and processor are located at a second location.

8. The method of claim 7 in which the form is accessed by a user through the internet.

9. The method of claim 1 in which the group of patent references comprises a substantial or complete collection of the patent references for one or more countries.

10. The method of claim 1 in which the lists of part names are generated by using a processor to, for each patent reference, parse the specification and validate words in the specification as being part names or part identifiers, and generate a list of part names from the patent reference.

11. A method for searching a group of patent references, one or more of the patent references having associated a) one or more drawings, and b) a specification, in which a) and b) contain corresponding part identifiers, which are each associated with a part name in the specification, the specification containing a title and abstract, the method comprising:
displaying on one or more screens a search query interface with a text entry field;
in response to a user query event, performing with a processor a query, using text in the text entry field, of an index of a combination of lists of part names and one or more of titles and abstracts, the lists and one or more of titles and abstracts being stored on a computer readable medium, each list and one or more of title and abstract being associated with a respective patent reference of the group; and
displaying on the one or more screens a results list of one or more patent references found in the query.

12. The method of claim 11 further comprises creating the index by indexing a text block of title, abstract, and list.

13. An apparatus for searching a group of patent references, one or more of the patent references having associated a) one or more drawings, and b) a specification, in which a) and b) contain corresponding part identifiers, which are each associated with a part name in the specification, the apparatus comprising:
a server connected to the internet;
the server having a form module configured to serve on request a form with one or more text entry query fields;
the server connected to receive a user query event, the server having a query module configured to perform with a processor a query, using text in at least one of the text entry query fields received by the server in the user query event, of lists of part names, the lists being stored on a computer readable medium, each list being associated with a respective patent reference of the group; and
the server having a results module configured to serve, in reply to the user query event, a results list of one or more patent references found in the query.

14.-17. (canceled)
